(19) United States
(12) Patent Application Publication
(10) Pub. No.: US 2020/0112555 A1
(43) Pub. Date: Apr. 9, 2020

(54) APPARATUSES, METHODS, AND COMPUTER PROGRAM PRODUCTS FOR SECURE ACCESS CREDENTIAL MANAGEMENT

(71) Applicant: Averon US, Inc., Henderson, NV (US)

(72) Inventors: Wendell BROWN, Henderson, NV (US); Mark KLEIN, Henderson, CA (US); Mark HERSCHBERG, Henderson, NV (US)

(21) Appl. No.: 16/594,836

(22) Filed: Oct. 7, 2019

Related U.S. Application Data
(60) Provisional application No. 62/742,187, filed on Oct. 5, 2018.

(51) Int. Cl. H04L 29/06

(52) U.S. Cl. CPC H04L 63/083; H04L 63/0853

(57) ABSTRACT

Various embodiments of the present disclosure provide apparatuses, systems, methods, and computer program products for secure access credential management. In this regard, embodiments are configured to automatically receive and utilize authentication credentials maintained by an identification and login system. Further, some embodiments, automatically facilitate updating authentication credentials to improve overall system security without impacting user experience. Some embodiments facilitate the provision of services by an external system through communications between the external system, a client device, and the identification and login system. Some embodiments utilize an out-of-band identification process via a trusted third-party system, such as a third-party login system or a one or more networked devices of an accessible device carrier network, to identify highly trustworthy device identification data for a particular client device.

### CROSS-REFERENCE TO RELATED APPLICATIONS

This application claims priority to U.S. Provisional Application No. 62/742,187 filed Oct. 5, 2018, the content of which is incorporated herein by reference in its entirety.

### TECHNOLOGICAL FIELD

Embodiments of the present disclosure relate generally to authenticating a user identity and/or user device identity, and specifically, to secure access credential management for access to external system(s) using out-of-band device identification information verification.

### BACKGROUND

Many services, systems, and the like provide functionality accessible to a user only after authentication of the user's identity or the identity of a client device used by the user to access such functionality. Often, such services, systems, and the like utilize a password, username and password combination, or other secret information that is distributed to users desiring to access the functionality. Further, such systems, services, and the like often will attempt to maximize system security by altering such secret information after some time and attempting to provide such altered secret information to users still permissioned to access the system, service, or the like. Applicant has discovered problems with current systems, methods, apparatuses, and computer program products for secure access credential management for external systems, and through applied effort, ingenuity, and innovation, Applicant has solved many of these identified problems by developing a solution that is embodied in the present disclosure, which is described in detail below.

### BRIEF SUMMARY

In general, embodiments of the present disclosure provided herein include systems, methods, apparatuses and computer program products for secure access credential management. Other systems, apparatuses, methods, computer readable media, and features will be, or will become, apparent to one with skill in the art upon examination of the following figures and detailed description. It is intended that all such additional systems, apparatuses, methods, computer readable media, and features be included within this description be within the scope of the disclosure, and be protected by the following claims.

In accordance with one aspect of the present disclosure, an apparatus for secure access credential management is provided. In at least one example embodiment, the apparatus includes at least one processor and at least one memory. The at least one memory includes computer-coded instructions thereon. The computer-coded instructions, in execution with the at least one processor, configure the apparatus to receive, from a client device, an authentication request data object, associated with an external system. The example apparatus is further configured to identify device identification information based on the authentication request data object, wherein the device identification information is associated with the client device. The example apparatus is further configured to compare the device identification information with a permissioned device information data object. The example apparatus is further configured to identify access credentials associated with the external system. The example apparatus is further configured to transmit an authentication information data object comprising the access credentials to the client device.

In some example embodiments of the apparatus, to identify the device identification information, the apparatus is configured to parse the authentication request data object to identify the device identification information included in the authentication request data object by a trusted third-party system.

In some example embodiments of the apparatus, to identify the device identification information, the apparatus is configured to transmit, to a trusted third-party system, a third-party authentication request data object configured based on the authentication request data object; and receive the device identification information from the trusted third-party system in response to the third-party authentication request data object.

In some example embodiments of the apparatus, the apparatus is further configured to identify effective time data associated with the access credentials, and the authentication information data object further comprises the effective time data.

In some example embodiments of the apparatus, the apparatus is further configured to store an device location event record, an authentication record, or both, to at least one record datastore based on the authentication request data object.

In some example embodiments of the apparatus, the apparatus is further configured to receive permissible device information from the client device or an admin device; and update the permissioned device information data object to include the permissible device information.

In some example embodiments of the apparatus, the apparatus is further configured to retrieve the permissioned device information data object from a third-party directory management service.

In some example embodiments of the apparatus, the apparatus is further configured to receive the access credentials from the client device; and update the permissioned device information data object to include the device identification information.

In some example embodiments of the apparatus, the apparatus is further configured to identify an updated access credentials in response to a credential update event; and transmit an updated authentication information data object comprising the updated access credentials to each client device of a connected client device set comprising the client device.

In some example embodiments of the apparatus, the apparatus is further configured to receive a permission removal request data object associated with removal device identification information; and update the permissioned device information data object to remove the removal device identification information.

In some example embodiments of the apparatus, the apparatus is further configured to receive supplemental information associated with the client device via at least one other networked connection, wherein the apparatus is configured to identify the device identification information based on the authentication request data object and at least a portion of the supplemental information.

In accordance with another aspect of the present disclosure, a computer-implemented method for secure access credential management is provided. The computer-implemented method may be implemented via any of a number of hardware implementations. In at least one example embodiment of the computer-implemented method, the computer-implemented method includes receiving, from a client device, an authentication request data object, associated with an external system. The example computer-implemented method further includes identifying device identification information based on the authentication request data object, wherein the device identification information is associated with the client device. The example computer-implemented method further includes comparing the device identification information with a permissioned device information data object. The example computer-implemented method further includes identifying access credentials associated with the external system. The example computer-implemented method further includes transmitting an authentication information data object comprising the access credentials to the client device.

In some example embodiments of the computer-implemented method, identifying the device identification information comprises parsing the authentication request data object to identify the device identification information included in the authentication request data object by a trusted third-party system.

In some example embodiments of the computer-implemented method, identifying the device identification information comprises transmitting, to a trusted third-party system, a third-party authentication request data object configured based on the authentication request data object; and receive the device identification information from the trusted third-party system in response to the third-party authentication request data object.

In some example embodiments of the computer-implemented method, the computer-implemented method further comprises identifying effective time data associated with the access credentials, and the authentication information data object further comprises the effective time data.

In some example embodiments of the computer-implemented method, the computer-implemented method further comprises storing an device location event record, an authentication record, or both, to at least one record datastore based on the authentication request data object.

In some example embodiments of the computer-implemented method, the computer-implemented method further comprises receiving permissible device information from the client device or an admin device; and updating the permissioned device information data object to include the permissible device information.

In some example embodiments of the computer-implemented method, the computer-implemented method further comprises retrieving the permissioned device information data object from a third-party directory management service.

In some example embodiments of the computer-implemented method, the computer-implemented method further comprises receiving the access credentials from the client device; and updating the permissioned device information data object to include the device identification information.

In some example embodiments of the computer-implemented method, the computer-implemented method further comprises identifying an updated access credentials in response to a credential update event; and transmitting an updated authentication information data object comprising the updated access credentials to each client device of a connected client device set comprising the client device.

In some example embodiments of the computer-implemented method, the computer-implemented method further comprises receiving a permission removal request data object associated with removal device identification information; and updating the permissioned device information data object to remove the removal device identification information.

In some example embodiments of the computer-implemented method, the computer-implemented method further comprises receiving supplemental information associated with the client device via at least one other networked connection, wherein identifying the device identification information is based on the authentication request data object and at least a portion of the supplemental information.

In accordance with another aspect of the present disclosure, a computer program product for secure access credential management is provided. In at least one example embodiment of the computer program product, the computer program product includes at least one non-transitory computer-readable storage medium having computer program code thereon. The computer program code, in execution with at least one processor, are configured to receive, from a client device, an authentication request data object, associated with an external system. The example computer program product is further configured to identify device identification information based on the authentication request data object, wherein the device identification information is associated with the client device. The example computer program product is further configured to compare the device identification information with a permissioned device information data object. The example computer program product is further configured to identify access credentials associated with the external system. The example computer program product is further configured to transmit an authentication information data object comprising the access credentials to the client device.

In some example embodiments of the computer program product, to identify the device identification information, the computer program product is configured to parse the authentication request data object to identify the device identification information included in the authentication request data object by a trusted third-party system.

In some example embodiments of the computer program product, to identify the device identification information, the computer program product is configured to transmit, to a trusted third-party system, a third-party authentication request data object configured based on the authentication request data object; and receive the device identification information from the trusted third-party system in response to the third-party authentication request data object.

In some example embodiments of the computer program product, the computer program product is further configured to identify effective time data associated with the access credentials, and the authentication information data object further comprises the effective time data.

In some example embodiments of the computer program product, the computer program product is further configured to store an device location event record, an authentication record, or both, to at least one record datastore based on the authentication request data object.

In some example embodiments of the computer program product, the computer program product is further configured to receive permissible device information from the client device or an admin device; and update the permissioned device information data object to include the permissible device information.

In some example embodiments of the computer program product, the computer program product is further configured to retrieve the permissioned device information data object from a third-party directory management service.

In some example embodiments of the computer program product, the computer program product is further configured to receive the access credentials from the client device; and update the permissioned device information data object to include the device identification information.

In some example embodiments of the computer program product, the computer program product is further configured to identify an updated access credentials in response to a credential update event; and transmit an updated authentication information data object comprising the updated access credentials to each client device of a connected client device set comprising the client device.

In some example embodiments of the computer program product, the computer program product is further configured to receive a permission removal request data object associated with removal device identification information; and update the permissioned device information data object to remove the removal device identification information.

In some example embodiments of the computer program product, the computer program product is further configured to receive supplemental information associated with the client device via at least one other networked connection, wherein the computer program product is configured to identify the device identification information based on the authentication request data object and at least a portion of the supplemental information.

In accordance with another aspect of the present disclosure, yet another apparatus for secure access credential management is provided. The other example apparatus similarly includes at least one processor and at least one memory. The at least one memory stores computer-coded instructions thereon. The computer-coded instructions are configured to, in execution with the at least one processor, configure the apparatus to cause transmission of an authentication request data object to an identification and login system through an out-of-band identification process configured to cause the identification and login system to receive device identification information, where the authentication request data object is associated with an external system to be accessed. The example apparatus is further configured to receive an authentication information data object comprising access credentials from the identification and login system. The example apparatus is further configured to transmit the access credentials to the external system associated with the authentication request data object to establish an authenticated connection with the external system.

In some embodiments of the example apparatus, to cause transmission of the authentication request data object to the identification and logic system through the out-of-band identification process, the apparatus is configured to detect a networked connection to a mobile device network; and transmit the access credentials via the mobile device network to cause identification of the device identification information using an out-of-band identification process by at least one networked device of the mobile device network.

In some embodiments of the example apparatus, to cause transmission of the authentication request data object to the identification and logic system through the out-of-band identification process, the apparatus is configured to detect a networked connection to a wireless device network that bypasses a mobile device network; disable the networked connection with the wireless device network; cause transmission of the authentication request data object via the mobile device network; and restore the networked connection with the wireless device network.

In some embodiments of the example apparatus, to cause transmission of the authentication request data object to the identification and logic system through the out-of-band identification process, the apparatus is configured to detect a networked connection to a wireless device network that bypasses a mobile device network; activate a primary connection with the mobile device network; cause transmission of the authentication request data object via the mobile device network; and deactivate the networked connection with the wireless device network.

In some embodiments of the example apparatus, to cause transmission of the authentication request data object to the identification and logic system through the out-of-band identification process, the apparatus is configured to detect a networked connection to a wireless device network that bypasses a mobile device network; and initiate at least one low-level API request configured to cause transmission of the authentication request data object via the mobile device network by routing a limited number of data packets to at least one networked device of the mobile device network.

In some embodiments of the example apparatus, the apparatus is further configured to transmit a services request data object to the external system; receive a services authentication URL in response to the services request data object; and access the services authentication URL to cause transmission of the authentication request data object, wherein the services authentication URL is accessed automatically or in response to user interaction data.

In some embodiments of the example apparatus, the apparatus is further configured to detect an external system associated with an unestablished authenticated connection, wherein the apparatus is configured to cause transmission of the authentication request data object in response to detecting the external system.

In some embodiments of the example apparatus, the apparatus is further configured to detect device location data within a geographic boundary defined by external system area data, wherein the apparatus is configured to cause transmission of the authentication request data object in response to detecting the device location data is within the geographic boundary.

In some embodiments of the example apparatus, the apparatus is further configured to receive, from the identification and login system, updated access credentials associated with the external system; and transmit the updated access credentials to the external system to re-establish the authenticated connection with the external system. Additionally or alternatively, in some such embodiments of the apparatus, the apparatus is further configured to store the updated access credentials as current access credentials for establishing the authenticated connection with the external system.

In some embodiments of the example apparatus, the apparatus is further configured to receive, from the identification and login system, updated access credentials associated with the external system; detect interruption of the authenticated connection with the external system; and retransmit, in an alternating pattern, one or more of the access credentials and the updated access credentials to receive an authentication response from the external system, the authentication response indicating the access credentials or the updated access credentials were successfully authenticated by the external system to re-establish the authenticated connection with the external system.

In accordance with another aspect of the present disclosure, yet another computer-implemented method for secure access credential management is provided. The other computer-implemented method may be implemented via any of a number of hardware implementations. In at least one example embodiment of this computer-implemented method, the computer-implemented method includes causing transmission of an authentication request data object to an identification and login system through an out-of-band identification process configured to cause the identification and login system to receive device identification information, where the authentication request data object is associated with an external system to be accessed. The computer-implemented method further includes receiving an authentication information data object comprising access credentials from the identification and login system. The computer-implemented method further includes transmitting the access credentials to the external system associated with the authentication request data object to establish an authenticated connection with the external system.

In some example embodiments of the computer-implemented method, causing transmission of the authentication request data object to the identification and logic system through the out-of-band identification process comprises detecting a networked connection to a mobile device network; and transmitting the access credentials via the mobile device network to cause identification of the device identification information using an out-of-band identification process by at least one networked device of the mobile device network.

In some example embodiments of the computer-implemented method, causing transmission of the authentication request data object to the identification and logic system through the out-of-band identification process comprises detecting a networked connection to a wireless device network that bypasses a mobile device network; disabling the networked connection with the wireless device network; causing transmission of the authentication request data object via the mobile device network; and restoring the networked connection with the wireless device network.

In some example embodiments of the computer-implemented method, causing transmission of the authentication request data object to the identification and logic system through the out-of-band identification process comprises detecting a networked connection to a wireless device network that bypasses a mobile device network; activating a primary connection with the mobile device network; causing transmission of the authentication request data object via the mobile device network; and deactivating the networked connection with the wireless device network.

In some example embodiments of the computer-implemented method, causing transmission of the authentication request data object to the identification and logic system through the out-of-band identification process comprises detecting a networked connection to a wireless device network that bypasses a mobile device network; and initiating at least one low-level API request configured to cause transmission of the authentication request data object via the mobile device network by routing a limited number of data packets to at least one networked device of the mobile device network.

In some example embodiments of the computer-implemented method, the method further comprises transmitting a services request data object to the external system; receiving a services authentication URL in response to the services request data object; and accessing the services authentication URL to cause transmission of the authentication request data object, wherein the services authentication URL is accessed automatically or in response to user interaction data.

In some example embodiments of the computer-implemented method, the method further comprises detecting an external system associated with an unestablished authenticated connection, wherein causing transmission of the authentication request data object is in response to detecting the external system.

In some example embodiments of the computer-implemented method, the method further comprises detecting device location data within a geographic boundary defined by external system area data, wherein causing transmission of the authentication request data object is in response to detecting the device location data is within the geographic boundary.

In some example embodiments of the computer-implemented method, the method further comprises receiving, from the identification and login system, updated access credentials associated with the external system; and transmitting the updated access credentials to the external system to re-establish the authenticated connection with the external system. Additionally or alternatively, in some example embodiments of the computer-implemented method, the method further comprises storing the updated access credentials as current access credentials for establishing the authenticated connection with the external system.

In some example embodiments of the computer-implemented method, the method further comprises receiving, from the identification and login system, updated access credentials associated with the external system; detecting interruption of the authenticated connection with the external system; and retransmitting, in an alternating pattern, one or more of the access credentials and the updated access credentials to receive an authentication response from the external system, the authentication response indicating the access credentials or the updated access credentials were successfully authenticated by the external system to re-establish the authenticated connection with the external system.

In accordance with another aspect of the present disclosure, yet another computer program product for secure access credential management is provided. In at least one example embodiment of the other computer program product, the computer program product includes at least one non-transitory computer-readable storage medium having computer program code thereon. The computer program code, in execution with at least one processor, are configured to cause transmission of an authentication request data object to an identification and login system through an out-of-band identification process configured to cause the identification and login system to receive device identification information, wherein the authentication request data object is associated with an external system to be accessed. The example computer program product is further configured to receive an authentication information data object comprising access credentials from the identification and login system; and transmit the access credentials to the external system associated with the authentication request data object to establish an authenticated connection with the external system.

In some example embodiments of the computer program product, to cause transmission of the authentication request data object to the identification and logic system through the out-of-band identification process, the computer program product is configured to detect a networked connection to a mobile device network; and transmit the access credentials via the mobile device network to cause identification of the device identification information using an out-of-band identification process by at least one networked device of the mobile device network.

In some example embodiments of the computer program product, to cause transmission of the authentication request data object to the identification and logic system through the out-of-band identification process, the computer program product is configured to detect a networked connection to a wireless device network that bypasses a mobile device network; disable the networked connection with the wireless device network; cause transmission of the authentication request data object via the mobile device network; and restore the networked connection with the wireless device network.

In some example embodiments of the computer program product, to cause transmission of the authentication request data object to the identification and logic system through the out-of-band identification process, the computer program product is configured to detect a networked connection to a wireless device network that bypasses a mobile device network; activate a primary connection with the mobile device network; cause transmission of the authentication request data object via the mobile device network; and deactivate the networked connection with the wireless device network.

In some example embodiments of the computer program product, to cause transmission of the authentication request data object to the identification and logic system through the out-of-band identification process, the computer program product is configured to detect a networked connection to a wireless device network that bypasses a mobile device network; and initiate at least one low-level API request configured to cause transmission of the authentication request data object via the mobile device network by routing a limited number of data packets to at least one networked device of the mobile device network

In some example embodiments of the computer program product, the computer program product is further configured to transmit a services request data object to the external system; receive a services authentication URL in response to the services request data object; and access the services authentication URL to cause transmission of the authentication request data object, wherein the services authentication URL is accessed automatically or in response to user interaction data.

In some example embodiments of the computer program product, the computer program product is further configured to detect an external system associated with an unestablished authenticated connection, wherein the computer program product is configured to cause transmission of the authentication request data object in response to detecting the external system.

In some example embodiments of the computer program product, the computer program product is further configured to detect device location data within a geographic boundary defined by external system area data, wherein the computer program product is configured to cause transmission of the authentication request data object in response to detecting the device location data is within the geographic boundary.

In some example embodiments of the computer program product, the computer program product is further configured to receive, from the identification and login system, updated access credentials associated with the external system; and transmit the updated access credentials to the external system to re-establish the authenticated connection with the external system. Additionally or alternatively, in some embodiments of the computer program product, the computer program product is further configured to store the updated access credentials as current access credentials for establishing the authenticated connection with the external system.

In some example embodiments of the computer program product, the computer program product is further configured to receive, from the identification and login system, updated access credentials associated with the external system; detect interruption of the authenticated connection with the external system; and retransmit, in an alternating pattern, one or more of the access credentials and the updated access credentials to receive an authentication response from the external system, the authentication response indicating the access credentials or the updated access credentials were successfully authenticated by the external system to re-establish the authenticated connection with the external system.

In accordance with another aspect of the present disclosure, yet another apparatus for secure access credential management is provided. The other example apparatus similarly includes at least one processor and at least one memory. The at least one memory stores computer-coded instructions thereon. The computer-coded instructions are configured to, in execution with the at least one processor, configure the apparatus to receive, from a client device, an authentication request data object, associated with an external system. The example apparatus is further configured to identify device identification information based on the authentication request data object, wherein the device identification information is associated with the client device. The example apparatus is further configured to receive, from the external system, a services identity request data object associated with the client device. The example apparatus is further configured to transmit an identity response data object to the external system, the identity response data object based on the device identification information.

In accordance with another aspect of the present disclosure, yet another computer-implemented method for secure access credential management is provided. The other computer-implemented method may be implemented via any of a number of hardware implementations. In at least one example embodiment of this computer-implemented method, the computer-implemented method includes receiving, from a client device, an authentication request data object, associated with an external system. The example computer-implemented method further includes identifying device identification information based on the authentication request data object, where the device identification information is associated with the client device. The example computer-implemented method further includes receiving, from the external system, a services identity request data object associated with the client device. The example computer-implemented method further includes transmitting an identity response data object to the external system, the identity response data object based on the device identification information.

In accordance with another aspect of the present disclosure, yet another computer program product for secure access credential management is provided. In at least one example embodiment of the other computer program product, the computer program product includes at least one non-transitory computer-readable storage medium having computer program code thereon. The computer program code, in execution with at least one processor, are configured to receive, from a client device, an authentication request data object, associated with an external system. The example computer program product is further configured to identify device identification information based on the authentication request data object, wherein the device identification information is associated with the client device. The example computer program product is further configured to receive, from the external system, a services identity request data object associated with the client device. The example computer program product is further configured to transmit an identity response data object to the external system, the identity response data object based on the device identification information.

In accordance with another aspect of the present disclosure, yet another apparatus for secure access credential management is provided. The example apparatus similarly includes at least one processor and at least one memory. The at least one memory stores computer-coded instructions thereon. The computer-coded instructions are configured to, in execution with the at least one processor, configure the apparatus to transmit a services request data object to the external system. The example apparatus is further configured to receive a services authentication URL in response to the services request data object, the services authentication URL configured to enable communications with an identification and login system. The example apparatus is further configured to access the services authentication URL to cause transmission of an authentication request data object to the identification and login system using an out-of-band identification process configured to cause the identification and login system to receive device identification information, where the authentication request data object is associated with an external system to be accessed, and where the services authentication URL is accessed automatically or in response to user interaction data. The example apparatus is further configured to transmit an identity response data object to the external system. The example apparatus is further configured to receive a services response data object from the external system based on the identification and login system.

In some example embodiments of the apparatus, the services request data object comprises user-input or device-asserted device information to be compared with the device identification information to authenticate the client device.

In some example embodiments of the apparatus, the apparatus is further configured to receive a services response data object from the external system based on the identification and login system.

In accordance with another aspect of the present disclosure, yet another computer-implemented method for secure access credential management is provided. The other computer-implemented method may be implemented via any of a number of hardware implementations. In at least one example embodiment of this computer-implemented method, the computer-implemented method includes transmitting a services request data object to the external system. The example computer-implemented method includes receiving a services authentication URL in response to the services request data object, the services authentication URL configured to enable communications with an identification and login system. The example computer-implemented method includes accessing the services authentication URL to cause transmission of an authentication request data object to the identification and login system using an out-of-band identification process configured to cause the identification and login system to receive device identification information, where the authentication request data object is associated with an external system to be accessed, and where the services authentication URL is accessed automatically or in response to user interaction data. The example computer-implemented method includes transmitting an identity response data object to the external system. The example computer-implemented method includes receiving a services response data object from the external system based on the identification and login system.

In some example embodiments of the computer-implemented method, the services request data object comprises user-input or device-asserted device information to be compared with the device identification information to authenticate the client device.

In some example embodiments of the computer-implemented method, the computer-implemented method further comprises receiving a services response data object from the external system based on the identification and login system.

In accordance with another aspect of the present disclosure, yet another computer program product for secure access credential management is provided. In at least one example embodiment of the other computer program product, the computer program product includes at least one non-transitory computer-readable storage medium having computer program code thereon. The computer program code, in execution with at least one processor, are configured to transmit a services request data object to the external system. The example computer program product is further configured to receive a services authentication URL in response to the services request data object, the services authentication URL configured to enable communications with an identification and login system. The example computer program product is further configured to access the services authentication URL to cause transmission of an authentication request data object to the identification and login system using an out-of-band identification process configured to cause the identification and login system to receive device identification information, where the authentication request data object is associated with an external system to be accessed, and where the services authentication URL is accessed automatically or in response to user interaction data. The example computer program product is further configured to transmit an identity response data object to the external system. The example computer program product is further configured to receive a services response data object from the external system based on the identification and login system.

In some example embodiments of the computer program product, the services request data object comprises user-input or device-asserted device information to be compared with the device identification information to authenticate the client device.

In some example embodiments of the computer program product, the computer program product is further configured to receive a services response data object from the external system based on the identification and login system.

The above summary is provided merely for purposes of summarizing some example embodiments to provide a basic understanding of some aspects of the disclosure. Accordingly, it will be appreciated that the above described embodiments are merely examples and should not be construed to narrow the scope or spirit of the disclosure in any way. It will be appreciated that the scope of the disclosure and the appended claims encompass many potential embodiments in addition to those summarized, some of which will be further described below.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with at least one embodiment of the present disclosure;

FIG. 3 illustrates a block diagram of another example apparatus that may be specially configured in accordance with at least one example embodiment of the present disclosure;

FIG. 4 illustrates an example data flow diagram of an example system in accordance with at least one example embodiment of the present disclosure;

FIGS. 5-10 illustrate example flowcharts depicting example operations for secure access credential management performed by a specially configured identification and login system in accordance with at least one example embodiment of the present disclosure;

FIGS. 11-14 illustrate example flowcharts depicting example operations for secure access credential management performed by a specially configured client device in accordance with at least one example embodiment of the present disclosure;

FIG. 15 illustrates yet another example data flow diagram of another example system in accordance with at least one example embodiment of the present disclosure;

FIG. 16 illustrates another example flowchart depicting example operations for secure access credential management performed by a specially configured identification and login system in accordance with at least one example embodiment of the present disclosure; and

FIG. 17 illustrates another example flowchart depicting example operations for secure access credential management performed by a specially configured client device in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Conventionally, external systems are secured by static access credentials that generally remained unchanged. For example, in one context, a Wi-Fi network usually utilizes a password without a particular username associated with the user. In this regard, if a corporate Wi-Fi network password remains unchanged, terminated employees and/or unauthorized personnel that have obtained access credentials may continue to access the network. Often, access credentials may remain unchanged for a significant period of time (e.g., several weeks, months, or even years in a row). Altering such credentials requires each user to acquire and input the altered access credentials. In this regard, altered access credentials may be distributed via email or another internal service requiring client device or user authentication. In this regard, once the access credentials are altered (e.g., a new password is distributed and becomes effective), any user that is not prepared with the altered access credentials will lose access to the network. Users losing access to the network slows or halts productivity, and requires network functionality or significant human effort to provide alternative methodologies for obtaining the altered access credentials.

In another context, a networked service provided via an external system is similarly affected by such deficiencies. For example, a username and password combination may serve as access credentials for accessing functionality provided associated with the external system (e.g., internal email functionality, one or more internal applications, and/or the like). Users may be required to update their access credentials periodically, for example upon certain events and/or at periodic time intervals. An entity may require such access credentials be changed for preventing credential sharing, fishing attacks, and other unauthorized access by illicit acquisition of specific access credentials. However, such contexts similarly suffer from the new access credentials expensive, inconvenient, and/or otherwise technically inefficient credential distribution processes, or requires that users be provided functionality for altering their access credentials and that the users do utilize such functionality.

Embodiments of the present disclosure provide secure automatic access credential management, for example for accessing an external system such as a network or a networked service. The secure automatic access credential management, in some embodiments, utilizes an identification and login system configured to receive a specially configured authentication request data object associated with accessing an external system, identify device identification information associated with the client device that transmitted the authentication request, determine whether the device identification information indicates the client device is permissioned to access the external system by retrieving access credentials, and providing the access credentials to the client device for use in accessing the external system. The identification and login system may maintain and/or receive various information associated with the access credentials, for example a permissioned device information data object associated with client devices permissioned to access a corresponding external system, corresponding device access credentials for each permissioned device identification information, and/or effective time data for stored access credentials. The identification and login system may be in communication with the external system and/or a control system associated with external system that is configured to provide such stored information, credential update events, and/or the like.

Various device identification information may be obtained and verified directly via a variety of third-party entities. For example, in some embodiments, the device identification information may be a mobile phone number associated with a client device that transmitted an authentication request data object to the identification and login system. The device identification information may be automatically obtained and/or verified by a networked device of a carrier network associated with the client device, for example through one or more out-of-band identification processes. In other embodiments, other device identifiers, IP addresses, or the like may be received and/or obtained and verified by a corresponding entity, such as a network host entity, Internet service provider entity, or the like. Some or all of the device identification information may be automatically identified, and not require any submission by the user or information asserted by the client device. In this regard, the device identification information may be provided by a third-party entity trusted to securely identify the device identification information and thus serving as a proxy for identifying the user. In one example context, a networked device is configured to identify a mobile telephone number or other identifying account information through secure processes such as SIM, eSIM, iSIM, or similar techniques that are conventionally secure to enable accurate billing of a mobile customer. In this regard, the identified mobile telephone number may be trusted as highly accurate for billing purposes, and further received and utilized by the identification and login system for performing identification and retrieving access credentials. Further, in some contexts, device identification information is stored by external systems for providing functionality (e.g., mobile phone numbers stored by a system for unique user identifiers), and thus is readily usable for user verification purposes.

In this regard, the identification and login system is configured to verify the identity of the client device and/or associated user in a highly trusted manner using an out-of-band identification process that identifies device identification information. This process may be performed automatically upon transmission from a client device, and in some contexts requires neither user input nor trust of any client device-submitted information. Upon automatically identifying access credentials associated with device identification information (which can be trusted as correct), such access credentials may be securely transferred to the client device and stored by the client device for continuous use with initiating an authenticated connection with the external system (for example using known secure transmission protocols).

Embodiments enable access credentials to be readily updated to increase security without inconveniencing users or requiring additional human and/or technological resources for handling users that lose access to updated access credentials. For example, newly updated access credentials may be seamlessly distributed to connected client devices when desired or required, where the device identification information serves to ensure the proper client device receives the corresponding proper access credentials. Effective time data may be maintained associated with access credentials, such that as updated access credentials are distributed, they are stored by the client device as current access credentials and used for accessing the functionality of the external system until the effective time data expires. At such a time, newly updated access credentials may be automatically received by the identification and login system and distributed to the various connected client devices. Alternatively, in other embodiments, newly updated access credentials may be automatically distributed in association with an automatically detected or user-initiated credential update event (e.g., initiated by an admin of the external system in response to a possible unauthorized access event, firing of an employee, or other indication).

Similarly, in embodiments, a client device may be specially configured for storing one or more sets of access credentials (e.g., at least current access credentials, and in some embodiments updated access credentials to be used next). The client device may be similarly configured to utilize current access credentials for initiating and/or maintaining an authenticated connection with an external system until updated access credentials are required to be used (e.g., upon expiry of the effective time data or at the time of a credential update event). The access credentials may be updated automatically by the specially configured user device based on the stored current access credentials and/or stored updated access credentials. In this regard, the specially configured client device enables the authenticated connection with the external system to continue even when access credentials are automatically updated with at most a very brief interruption to the user. In some such contexts, the interruption to the user may be insignificant enough that the user does not perceive the interruption at all, and/or the interruption otherwise does not affect the user's activities via the client device.

The client device may be further specially configured to provide such functionality automatically upon entering particular zones and/or coming into contact with particular networks. For example, as a client device enters the coverage area of a Wi-Fi network (e.g., a new network or a previously accessed network), the client device may perform such an identification process in communication with the identification and login system to retrieve access credentials associated with accessing the network without action by the user. In this regard, some embodiments enable automatic connection with an external system (e.g., a network or network service) and continue to enable access to the external system while consistently updating access credentials to improve system security. Thus, in some such embodiments, an authenticated connection with an external system is established and maintained in a secure and trustworthy manner without requiring any user interaction.

### Definitions

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. The client devices described herein communicate with one or more systems or servers, for example an identification and login system and/or one or more external systems, via one or more communication network(s).

The term “device identification information” refers to electronically managed data or information that uniquely identifies a particular client device, or an associated user. In some such embodiments, due to the nature of the client device being kept in close control by an associated user, identification of device identification information confirms and/or otherwise authenticates the identity of a user associated with the client device associated with the device identification information. Non-limiting examples of device identification information include an international mobile subscriber identity (IMSI) or telephone number, international mobile equipment identifier, integrated circuit card identifier (ICCID), media access control (MAC) address, and internet protocol (IP) address. Other examples of device identification information include user account credentials (such as a username and password). In some embodiments, a trusted third-party device and/or system is configured to identify device identification information associated with a client device using a highly-secure out-of-band identification process, for example in response to requests from and/or other communication with an identification and login system.

The terms “carrier header enrichment,” “packet header enrichment,” and “header enrichment process” refer to a process for authenticating a mobile, Internet-of-Things (IoT) device, or other uniquely identified device, or a device owner, via a Direct Autonomous Authentication process, involving a process in which packet headers comprising device identification information, for example, are “injected” into a transmission, or otherwise associated with the transmission, such as by a carrier via a carrier device, network provider, or other entity via a login process. For example, in some embodiments, a network may inject a mobile phone number associated with a mobile device within packet headers of a transmission from the mobile device. In this manner, an identification and login system may obtain device-identity information associated with a client device, and/or associated with the user of the client device, without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “external system” refers to a networked device, computing hardware, or a combination of hardware and software for providing particular functionality requiring user identity authentication (e.g., via one or more identification processes). Examples of external systems include, without limitation, systems associated with accessing one or more network connections (e.g., Wi-Fi network(s), WLAN networks, or the like), and/or systems associated with networked services. In an example context, an example external system is embodied by a wireless router, beacon, or other wireless access point. In another example context, an example external system is embodied by an application server accessible via one or more networked connections.

The term “trusted third-party system” refers to one or more devices, servers, systems, sub-systems, or other computing hardware configured for performing one or more out-of-band identification processes in communication with an identification and login system. In this regard, the trusted third-party system is configured to identify, using a highly-secure or otherwise highly-trusted identification process, device identification information associated with a particular client device, for example a client device that originated a request data object or other data packet. In an example context, a trusted third-party system is a network device included in a mobile device network, and configured for performing a header enrichment process for particular transmitted data. In another example context, a trusted third-party system is a server or other computing hardware associated with an internet-of-things (IoT) enabled device, and configured to identify device identification information associated with the IoT device (a serial number, other unique device identifier, or the like) using a highly-trusted identification process.

The term “identification and login system” refers to computing hardware, circuitry, one or more devices, servers, systems, and/or sub-systems, configured for receiving one or more requests associated with authentic identification of a client device or associated user, identifying device identification information associated with such the client device and/or user identity, and retrieving and/or otherwise providing access credentials for accessing functionality associated with an external system. In one example context, for example for an external system embodying a network access point (e.g., a router) or a networked service device (e.g., an application server), an identification and login system includes one or more servers, devices, or other computing hardware to receive an authentication request data object from a client device, identify device identification information associated with the client device, optionally determine if the device identification information is permissioned to access the external system associated with the authentication request data object, identify access credentials associated with the external system, and provide the access credentials to the client device. In another example context, for example for an external system embodying a network access point or a networked service device, the identification and login system includes one or more servers, devices, or other computing hardware to receive an authentication request data object from a client device, identify device identification information associated with the client device, optionally determine if the device identification information is permissioned to access the external system associated with the authentication request data object, receive a services identity request data object from the external system, and provide the external system one or more of access credentials associated with the client device (e.g., for accessing the external system) or the identified device identification information. In this regard, the identification and login system may serve as an authority for the external system with respect to the identity of the client device (and/or an associated user) desiring to access the external system.

The term “third-party authentication request data object” refers to electronically managed data transmitted from an identification and login system to a trusted third-party system requesting device identification information associated with a particular client device. In some embodiments, a third-party authentication request data object is based on an authentication request data object received by the identification and location system from a client device, for example such that the third-party authentication request data object is configured to include information identifying the client device to be used in one or more secure identification processes performed by the trusted third-party system. In some such embodiments, the third-party authentication request data object includes, or is embodied by, the authentication request data object forwarded by the identification and location system.

The term “location data” refers to electronically managed data representing an absolute or relative location of a server, device, or computing hardware. Examples of device location data include, without limitation, a GPS data coordinate, a latitude/longitude coordinate, an address, a zip code, position data relative to a beacon or other anchor location, or any combination thereof. Device location data may be identified and/or otherwise detected using any of a myriad of methodologies, including, without limitation, GPS, Wi-Fi signatures, cell tower triangulation and/or other triangulation methodologies, Bluetooth signal proximity determination, or direct user input.

The term “device location data” refers to location data representing a particular location of a client device. In some contexts, device location data refers to a current location of a client device. It should be appreciated that device location data may be represented in any of a myriad of data formats.

The term “external system area data” refers to one or more portions of location data associated with an external system. In some embodiments, external system area data defines a “geographic boundary,” which refers to a machine-readable and/or human-readable interpretation of a bounded region. In some contexts, external system area data includes a single portion of location data defining a geographic boundary (e.g., zip code data). In other contexts, external system area data includes multiple portions of location data defining a geographic boundary (e.g., location data points to be connected to form the geographic boundary).

The term “access credentials” refers to data associated with accessing functionality of a corresponding external system. In some embodiments, access credentials represent secure data to be used by all users for accessing functionality of the corresponding system. In an example context, the access credentials represent a wireless network password or other system-level password. In other embodiments, access credentials represent secure data to be used by an individual user for accessing functionality of the corresponding system. In an example context, the access credentials represent a password associated with a particular user, or a password and user identifier (e.g., a username) combination associated with a particular user, for accessing functionality for the corresponding external system. In some embodiments, access credentials are set by the external system, and either stored by the external system and retrieved by an identification and login system, or stored by the identification and login system with updates triggered by the external system. It should be appreciated that, in some embodiments, an identification and login system is configured to store any number of access credentials associated with any number of external systems. In some embodiments a client device receives access credentials from the identification and login system for forwarding to the external system to initiate an authenticated connection. Additionally or alternatively, in some embodiments, a client device is configured to store access credentials and/or corresponding effective time data as current access credentials for use in maintaining an authenticated connection with a corresponding external system.

The term “effective time data” refers to electronically managed data representing a timestamp, or timestamp interval, after which associated access credentials are obsolete or otherwise no longer acceptable for establishing and/or re-establishing an authenticated connection with an external system. In this regard, in some contexts, a client device may utilize access credentials before the timestamp represented by the effective time data to establish and/or re-establish such an authenticated connection. In other contexts, a client device may utilize access credentials during a timestamp interval represented by the effective time data to establish and/or re-establish such an authenticated connection. In some embodiments, a client device must receive updated access credentials associated with an updated effective time to establish and/or re-establish an authenticated connection upon expiry of the effective time data for the current access credentials.

The term “authentication information data object” refers to electronically managed data configured for transmission from an identification and login system to an external system or a client device, where the electronically managed data is to be used for accessing functionality associated with an external system. In some embodiments, the authentication information data object includes at least access credentials to be used for accessing functionality of a corresponding external system. Additionally or alternatively, in some embodiments, the authentication information data object includes at least device identification information utilized for identifying a client device requesting functionality from an external system.

The term “admin device” refers to a client device authenticated with a user account permissioned for managing data associated with an external system. For example, in an example context, an admin device is embodied by a mobile device or personal computing device on which a user has accessed a software application (e.g., a web-based application or local application) and authenticated their identity to access functionality for managing a permissioned device information data object associated with an external system (e.g., adding device identification information and/or removing device identification information from the permissioned device information data object).

The term “credential update event” refers to electronically managed data, identified by a system, that indicates access credentials associated with a particular external system are to be updated. A credential update event may be detected by a client device, an identification and login system, and/or an external system, and may be detected and/or identified independent of the other systems. In some embodiments, an identification and login system is configured to detect a credential update event in response to detecting the effective time associated with one or more access credentials has expired. Alternatively, in some embodiments, a credential event update is identified in response to and/or otherwise based on one or more incoming requests, transmissions, or other signals from an external system configured to control such access credentials. For example, in some embodiments, an external system associated with maintaining access credentials for accessing a networked connection, or another third-party networked service for example, generates and transmits a request representing a credential update event at predetermined intervals to provide updated access credentials.

The term “updated access credentials” refers to newly generated access credentials configured to replace previous access credentials associated with one or more user accounts. For example, in one example context, updated access credentials refers to a new network password associated with establishing a network connection (e.g., an updated Wi-Fi network password) to be used by a particular user account or by any user account to access the network connection. In another example context, updated access credentials comprises an updated password and/or username associated with a user account for a particular user account. It should be appreciated that each updated access credentials may be associated with an updated effective time data. The term “updated authentication information data object” refers to an authentication information data object for providing updated access credentials and/or corresponding updated effective time data.

The term “authentication request data object” refers to electronically managed data transmitted from a client device to an identification and login system representing a user request for the identification and login system to authenticate the identity of the client device, and/or a corresponding user of the client device. In some embodiments, the authentication request data object represents a request to transmit information identifying whether an identification process was successful (e.g., whether the identity of the client device, and/or associated user of the client device, was successful) to the client device transmitting the request and/or the external system associated with the request data object. Additionally or alternatively, in some embodiments, the authentication request data object represents a request for the identification and login system to identify corresponding access credentials and/or provide such access credentials to the client device transmitting the request data object in a circumstance where one or more identification process(es) were successfully completed. In some such contexts, the access credentials identified and/or provided are configured for use by the client device in establishing an authenticated connection, and/or otherwise beginning an authenticated session, for accessing functionality provided by the external system associated with the authentication request data object.

The term “permissible device information” refers to device identification information and/or corresponding access credentials permissioned to access an external system associated with an authentication request data object. In this regard, the permissible device information embody whitelisted information, for example associated with a client device, provisioned to access an external system. In some embodiments, permissible device information is stored by an identification and login system. In some such embodiments, a particular user (e.g., an administrator) accesses the identification and login system, either directly or through an admin client device, to provide permissible device information to be stored.

The term “permissioned device information data object” refers to electronically managed data structure maintained by an identification and login system for storing permissible device information for a particular external system. In some embodiments, a permissioned device information data object is associated with an external system, for example such that the permissioned device information data object is retrievable based on the external system (or a corresponding external system identifier). In some embodiments, the permissioned device information data object is embodied by one or more of a list, a dictionary, a hashtable, an array, or another structured data object.

The term “permission removal request data object” refers to electronically managed information, transmitted by an external system, associated admin device, or other client device, indicating a request to remove particular device identification information from a permissioned device information data object. In some embodiments, the permission removal request data object includes at least an external system identifier usable to retrieve a permissioned device identification data object associated with the external system corresponding to the external system identifier. The term “removal device identification information” refers to particular device identification, associated with a corresponding client device, to be removed from the permissioned device information data object. In some embodiments, the permission removal request data object additionally or alternatively includes the removal device identification information.

The term “third-party directory management service” refers to software and/or hardware embodying an external system for managing permissible device information data object(s) for one or more external systems. For example, in one example context, a third-party directory management service refers to a cloud or local service that manages employee credentials along with profile information, for example including device identification information for client device(s) of each employee. In this regard, in some embodiments, an identification and login system is configured to communicate with the third-party directory management service used by a particular entity (e.g., an organization, group of users, corporation, or the like) to retrieve a permissioned device information data object associated with an external system of the entity. One or more users may utilize third-party applications and/or functionality to maintain information stored via the third-party directory management service.

The term “device location event record” refers to structured electronically managed data maintained by an identification and login system that indicates that a client device was associated with device location data within a geographic boundary associated with an external system. For example, in some such embodiments, an identification and login system is configured to generate and/or store a device location event record upon detecting that a client device is associated with device location data within a geographic boundary defined by external system area data for a particular external system. The device location event record, in some embodiments, is stored associated with the external system, such that device location event record(s) may be retrieved and processed to analyze user behavior associated with the external system (e.g., how long a user, and corresponding client device, was in a particular location associated with the external system, such as located in an aisle of a store and facing certain products). For example, in some embodiments, the device location event record includes, without limitation, device location data, arrival timestamp data, exit timestamp data, user profile data (e.g., biographical data), or any combination thereof.

The term “authentication record” refers to electronically managed data maintained by an identification and login system that indicates a particular client device was successfully authenticated (e.g., by identifying device identification information), or indicating that indicates a particular client device transmitted an authentication request data object. In some such embodiments, an authentication record includes device identification data and/or access credentials for a client device that originated an authentication request data object. Additionally or alternatively, in some embodiments, the authentication record includes additional client device identifiers and/or information, for example without limitation, one or more network identifiers, serial numbers, hardware identifiers, or a combination thereof. Additionally or alternatively in some embodiments, an authentication record includes authentication success data representing whether the identification of the client device was successfully authenticated (e.g., whether device identification information was successfully identified, and/or whether the device identification information was determined permissioned for accessing an external system for which access credentials were requested).

The term “record datastore” refers to one or more virtual and/or physical devices, systems, memories, computing hardware, or a combination thereof, for storing one or more records. In this regard, in some embodiments, a record datastore is configured for storing at least device location event record set and an authentication record set. In some such embodiments, a record datastore includes one or more sub-datastores. For example, in some embodiments, a record datastore includes a device location event record datastore configured for storing a device location event record set, and an authentication record datastore configured for storing an authentication record set. In some embodiments, a record datastore is embodied by a traditional datastore, distributed datastore, a blockchain datastore, a cloud datastore, or a combination thereof.

The term “connected client device set,” in regard to a particular external system, refers to zero or more client devices communicable with the external device and associated with access credentials received from an identification and login system for maintaining an authenticated connection with the external system. It should be appreciated that, in some embodiments, an identification and login system maintains a connected client device set for a particular external system (or multiple external systems). Additionally or alternatively, in some embodiments, an external system maintains its respective connected client device set for communication to an identification and login system.

The term “out-of-band identification process” refers to one or more verification methodologies for verifying a device identity associated with a client device, or a user identity associated with the client device. In some embodiments, the out-of-band identification process is performed by, or in communications with, a third-party system associated with a trusted third-party entity. Non-limiting examples of an out-of-band identification process include a header enrichment process, a user-account verification process, a third-party login process, and/or any combination thereof. In some embodiments, the out-of-band identification process utilizes secure identification techniques, for example SIM, eSIM, or similar methodologies for identifying the particular client device associated with a particular data transmission (e.g., a request, received data packets, or the like).

The term “supplemental information” refers to device identification information and/or other associated user information and/or client device information, received by an identification and login system using an in-band process. In some such embodiments, supplemental information includes user-submitted information and/or data automatically detected and relayed by the client device. Supplemental information may be used in addition to device identification information received via an out-of-band identification process for authenticating a client device identity and/or user identity.

The term “authenticated connection” refers to a state of secure communications between a client device and an external system using current access credentials. In some embodiments, current access credentials become out of date (e.g., due to expiry associated with corresponding effective time data or due to occurrence of a credentials update event) such that updated access credentials must be used to re-establish and/or otherwise continue utilizing the authenticated connection.

The term “networked connection” refers to connectivity with one or more devices, systems, or the like, over a pre-defined communications networks. In some embodiments a networked connection is configurable between a client device and a mobile device network and/or wireless device network. In some such contexts, a networked connection is utilized to receive and/or validate access credentials with an external system to initiate an authenticated connection. It should be appreciated that a client device may be configured to automatically detect, join, and/or request access to utilize one or more networked connections.

The term “mobile device network” refers to a cell tower network, carrier network, or the like configured to process transmissions sent to and/or sent from a client device. In some embodiments, for example where the client device is a smartphone or tablet device, the mobile device network accessible to the client device is based on the vendor or another point of sales entity associated with the client device.

The term “wireless device network” refers to another network, with which a client device is configurable to communicate over, controlled by a non-carrier entity or otherwise controlled by an entity not controlled by a client device-specific entity. Non-limiting examples of a wireless device network include Wi-Fi connections, WLAN connections, PAN connections, WAN connections, LAN connections, and/or any combination thereof, controlled by a third-party entity or service provider. It should be appreciated that, in some embodiments, a networked connection is established directly. In other embodiments, a networked connection is established via any number of intermediary networked devices (e.g., network nodes).

The term “networked device” refers to an endpoint or intermediary device associated with a network, including a mobile device network or wireless device network. It should be appreciated that, in some embodiments, one or more networked devices are configured with specialized functionality associated with transmitting data to and/or from an identification and login system. For example, in some embodiments, a networked device is configured to perform one or more out-of-band identification processes associated with the client device.

The term “primary connection” refers to a particular networked connection that a client device is configured to utilize to transmit one or more data packets, requests, or other transmissions. In some embodiments, a client device is configured to utilize only one primary connection at a time (e.g., a Wi-Fi connection or a mobile data connection. but not both), where the client device is configured to enable a user to select and/or configure which connection is to be used. In other embodiments, a client device is configured to provide software executed via the client device to select a primary connection based on current authenticated connections maintained by the client device.

The term “low-level API request” refers to one or more service layer, network layer, operating system layer, or hardware layer operations initiated on a specially configured client device for causing transmission one or more data packets to a networked device for use in an out-of-band identification process. In some embodiments, a specially configured client device is configured to execute an operation via one or more third-party application programming interfaces (APIs) or client device specific APIs (e.g., hardware or software specific APIs for a particular client or operating system) functioning as a low-level API request.

The term “services request data object” refers to electronically generated data transmitted from a client device to an external system requesting to initiate an authenticated session with the external system for accessing functionality provided by the external system. In some embodiments, an external system is configured to initiate one or more identification processes for identifying the client device from which the services request data object was transmitted, or a user identity associated with the client device. In some embodiments, the services request data object includes one or more data identifiers and/or data objects for accessing particular functionality provided by the external system.

The term “services authentication URL” refers to electronically managed data configured by an external system for use by a client device in accessing an identification and login system for identification verification associated with a particular services request data object. In some embodiments, a services authentication URL includes a specially configured uniform resource locator that is accessible by a specially configured client device for communicating with the identification and login system. In some embodiments, the services authentication URL is configured in whole or in part by the external system and/or the identification and login system in communication with the external system, for example to include one or more parameters for use in linking data maintained by the external system, client device, and/or identification and login system (for example, by generating a session identifier for inclusion in the services authentication URL). In some embodiments, the services authentication URL is configured to be accessible via the client device in response to user interaction with a corresponding interface element. In other embodiments, the services authentication is configured to be accessible automatically via the client device in response to receiving the services authentication URL.

The term “authentication notification data object” refers to electronically generated information transmitted from a client device to an external system indicating the client device has accessed a services authentication URL transmitted from the external system. In some contexts, the authentication notification data object includes information representing that the external system should communicate with the identification and login system to receive data indicating whether the client device was successfully authenticated by the identification and login system. In some embodiments, the authentication notification data object includes a client device identifier, a session identifier, or other information usable to retrieve corresponding information from an identification and login system.

The term “services identity request data object” refers to electronically managed data transmitted from an external system to an identification and login system requesting access credentials, associated data, and/or other information indicating whether a particular client device requesting services was successfully authenticated associated with device identification information. In some such embodiments, the external system is configured to transmit a services identity request data object in response to an authentication notification data object received from a client device, and is associated with a corresponding authentication request transmitted from a client device to the identification and login system. In some such embodiments, the external system receives an authentication information data object and/or corresponding device identification information, access credentials, effective time data, and/or a combination thereof, in response to the services identity request data object.

The term “services response data object” refers to electronically managed data generated and transmitted from an external system to a client device in response to services request data object. In some embodiments, the services response data object includes information indicating whether the identity of the client device that transmitted the services request data object, or a corresponding user identity, was successfully authenticated by the external system in communication with the identification and login system. In some embodiments, the services response data object includes data for the client device to utilize in maintaining an authenticated connection with the external system.

### Example System Architecture

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a variety of mobile terminals, mobile telephones, smartphones, laptop computers, tablet computers, or any combination of the aforementioned devices.

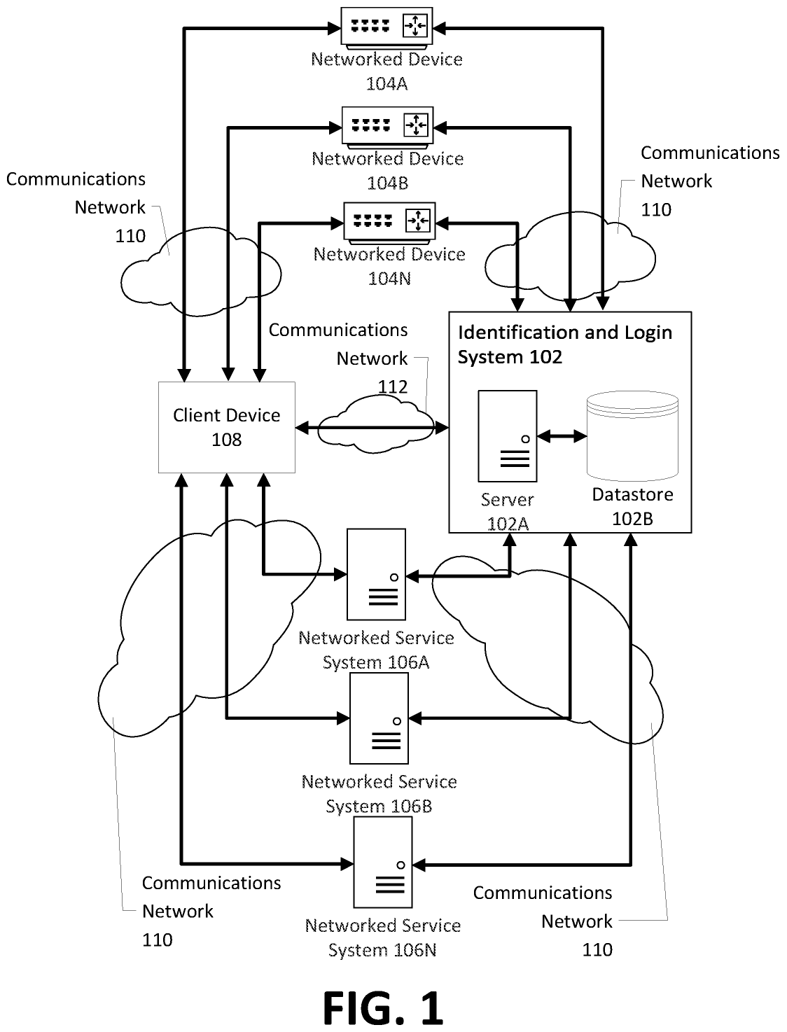

In this regard, FIG. 1 discloses an example computing system in which embodiments of the present disclosure may operate. FIG. 1 illustrates an overview for a system configured for secure access credential management. Specifically, the system includes a client device to establish and/or maintain an authenticated connection with an external system. The client device is configured to establish and/or maintain an authenticated connection with the external system (e.g., through re-establishing the authenticated connection associated with one or more instances of access credential updating) via communication with an identification and login system. The identification and login system is configured to, upon request by an client device to enable the client device to access an external system, identify and/or authenticate a user identity and/or client device identity, and use the identified information (e.g., device identification information) to facilitate the requested access if the client device is permissioned to access the external system.

As illustrated, the system includes a client device 108. In some example embodiments, the client device 108 may be embodied by any of a number of computing devices, hardware, or the like, which may be specially programmed in accordance with the functionality described herein. For example, in some embodiments, the client device 108 is specially configured to access functionality provided via a native software application (e.g., an “app”) executed via the client device. In other embodiments, the client device 108 is specially configured to access functionality provided via a web application accessible to the client device 108 via a browser application. In yet other embodiments, the client device 108 is configured to access specialized functionality of the identification and login system and/or an external system, as described herein, using third-party software applications, operating system functionality associated with the client device 108, and/or a combination thereof, without further specialized programming.

In some embodiments, the client device 108 is configured with an automatic login module. The automatic login module is, in some embodiments, configured to generate and/or transmit one or more requests, such as authentication requests, to the identification and login system 102 for requesting access to one or more external systems. Additionally or alternatively, in some embodiments, the automatic login module is configured for storing access credentials (e.g., current access credentials) used for establishing and/or maintaining an authenticated connection with one or more external systems. Further, in some embodiments, the automatic login module is configured for storing a plurality of access credentials (e.g., current access credentials and updated access credentials) to minimize interruption in providing functionality to the user of the client device 108 in the circumstance of a credential update event. In this regard, in some embodiments, the client device 108 is configured to enable an authenticated connection with one or more external system(s) automatically through communications with the identification and login system, and enable access to functionality provided by such external system(s) via the authenticated connection.

The system further includes a plurality of external systems that may be configured to provide functionality to one or more client devices, such as the client device 108. For example, example external systems include networked devices 104A-104N (collectively “networked devices 104”). Each of the networked devices 104 may embody computing hardware and/or corresponding software and/or firmware configured to enable the client device 108 to access an associated wireless device network. In an example context, each of the networked devices 104 is embodied by a wireless router and/or other wireless access point.

Each of the networked devices 104 may be secured by access credentials that must be submitted by a client device to initiate a corresponding authenticated connection. For example, in some embodiments, each of the networked devices 104 is protected by at least a network password, such that the network password must be distributed to users for initiating an authenticated connection. In other embodiments, each of the networked devices 104 is protected by a combination of a network identifier (e.g., a network name or service set identifier) and a network password. In some embodiments, the access credentials utilized to access each of the networked devices 104 are shared between users, such that each client device (e.g., the client device 108) can initiate an authenticated connection with a networked device using the same access credentials. In a particular context, for example, a Wi-Fi router password (or combination of SSID and password) may be used by all users to access a particular networked device of the networked devices 104.

In some embodiments, one or more of the networked devices 104 is configured, alone or in conjunction with a control system (not shown), to communicate with the identification and login system 102. The networked devices 104 may communicate with the identification and login system 102 to provide access credentials for use by one or more client devices, such as the client device 108. Additionally or alternatively, in some embodiments, the networked devices 104 are configured to, alone or in conjunction with an associated control system, initiate and/or detect one or more credential update events, generate updated access credentials, and/or communicate with the identification and login system 102 to provide updated access credentials. For example, a particular networked device of the networked devices 104 may be configured to generate updated access credentials after determining a particular time interval has elapsed (e.g., represented by an effective time data) and provide these updated access credentials to the identification and login system 102 for distribution to currently connected client devices and/or new client devices requesting access.

Other example external systems include networked service systems 106A-106N (collectively “networked service systems 104”). Each of the networked service systems 106 may be embodied by any of various computing hardware, and/or corresponding software and/or firmware to enable the client device 108 to access particular service-related functionality. In an example context, each of the networked service systems 106 is embodied by a server (e.g., either local or remote/“cloud” server), processing device, database, or the like. For example, one or more of the networked service systems 106 may be embodied by a corporate server configured to provide internal software application functionality (e.g., a corporate email server, remote desktop management server, or the like).

Each of the networked service systems 106 may similarly be secured by access credentials that a client device must submit to initiate a corresponding authenticated connection. For example, in some embodiments, one or more of the networked service systems 106 is secured by at least a password, or a username and password combination. In some such contexts, each username and password combination is associated with a user account, such that upon providing a valid username and password combination to a networked service system of the networked service systems 106, the networked service system initiates an authenticated session associated with an authenticated user account linked to the valid username and password combination. In this regard, in some embodiments, it should be appreciated that some external systems may be secured by access credentials comprising a plurality of sub-components (e.g., a username, a password, and/or other data), while other external systems are secured by access credentials comprising only a single component (e.g., a password).

In some embodiments, one or more of the networked service systems 106 is configured, alone or in conjunction with a control system (not shown), to communicate with the identification and login system 102. The networked service systems 106 may communicate with the identification and login system 102 to provide access credentials associated with one or more client devices, such as the client device 108. For example, in some embodiments, the networked service system 106A is configured to provide access credentials for linking to, or already associated with, device identification information for a particular client device permissioned and/or previously provisioned to have access the authenticated user account associated with the access credentials. In this regard, the networked service system 106A may enable the identification and login system 102 to provide access credentials to the client device 108 based on identified device identification information associated with the client device 108. In other embodiments, one or more of the networked service systems 106 may be configured to communicate with the identification and login system 102 to receive device identification information associated with the client device 108, which may be used to identify an associated authenticated user account, determine whether to permit and/or initiate a transaction, and/or for determining whether to provide other functionality to the client device 108.

Additionally or alternatively, in some embodiments, one or more of the networked service systems 106 is configured, alone or in conjunction with a control system, to communicate with the identification and login system 102 to initiate and/or detect or one or more credential update events, generate updated access credentials, and/or provide the updated access credentials. For example, a particular networked service system of the networked service systems 106 may be configured to generate updated access credentials after determining a particular time interval has elapsed (e.g., represented by effective time data corresponding to current access credentials) and provide these updated access credentials to the identification and login system 102 for distribution to appropriate currently connected client devices and/or new client devices requesting access.

The system further includes identification and login system 102. The identification and login system 102 may be embodied by one or more computing systems, apparatuses, devices, or the like, configured for secure access credential management. In this regard, the identification and login system 102 includes computing hardware for receiving authentication requests, identifying device identification information, optionally authenticating such device identification information (e.g., by comparing the device identification information with permissioned device identification information), and/or transmitting an authentication information data object that includes the device identification information, access credentials, and/or the like. Further, the identification and login system 102 includes computing hardware for maintaining updated access credentials and distributing such updated access credentials to associated client devices.

In some embodiments, for example as illustrated, the identification and login system 102 includes one or more servers, for example server 102A, and one or more datastores, for example datastore 102B. Server 102A may be configured via hardware, software, or a combination thereof, to provide communication functionality between the identification and login system 102 and one or more other devices. For example, in some embodiments, the server 102A includes hardware and/or software for communicating with one or more external systems, such as the networked devices 104 and/or the networked service systems 106. In some such circumstances the server 102A may provide functionality associated with receiving access credentials and/or updated access credentials, receiving and/or transmitting request data object(s) and associated response data object(s), and/or authenticating device identification information associated with one or more client devices (e.g., by retrieving and/or utilizing permissioned device information data object(s) associated with such external systems).

Additionally or alternatively, in some embodiments, the server 102A may provide communication functionality between the identification and login system 102 and one or more client devices, such as the client device 108. The server 102A may provide such functionality in addition to, or otherwise associated with, receiving authentication request data object(s) from a client device and/or services identity request data object(s) from an external system. In this regard, the server 102A may be configured to receive authentication request data object(s) from a client device, such as client device 108, identify access credentials in response to the request, and transmit such access credentials to the client device for use in establishing an authenticated connection with an external system. Alternatively or additionally, the server 102A may be configured to receive services identity request data object(s) from an external device, such as one of the networked devices 104 or the networked service systems 106, identify access credentials and/or device identification information in response to the request, and transmit such access credentials and/or device identification information to the external system for use in one or more decision-making processes (e.g., whether to establish an authenticated connection with a client device, whether to allow a transaction initiated by a client device, or the like).

The identification and login system 102 further includes datastore 102B. The datastore 102B may be embodied by one or more hardware and/or software systems for storing, retrieving, and/or otherwise managing data utilized in providing functionality associated with secure access credentials management. In some embodiments, the datastore 102B may be configured to store at least user account information, client device identifiers and/or device identification information associated with one or more users, user accounts, and/or client devices, external system identification information, and/or the like, for communicating with one or more other devices in the system. Additionally or alternatively, the datastore 102B may be configured to store access credentials, updated access credentials, effective time data associated with stored access credentials, permissioned device information data object(s) associated with one or more connected external system(s), or any combination thereof. The datastore 102B may be configured to perform some, or all, storage functionality independently. In other embodiments, the server 102A is configured to communicate with the datastore 102B for performing such storage actions, for example to retrieve data from the datastore 102B, store data to the datastore 102B, and/or otherwise maintain or alter data stored in the datastore 102B.

The datastore 102B may be embodied by any number and/or combination of known storage devices and configurations. In some embodiments, the datastore 102B may include at least one module configured via hardware, software, or combination thereof. In some embodiments, the datastore 102B may include at least one storage device, such as one or more memories, hard disks, network attached storage (NAS) device(s), or a separate database server or servers. The datastore 102B may be configured to store specific information, data, and/or signals received over a network or generated, determined, identified, and/or otherwise utilized in operations performed by the identification and login system 102. For example, in some embodiments, the datastore 102B is configured to store specific information used in functionality provided through the server 102A.

Further, it should be appreciated that the database 102B may be embodied by a single database, or a plurality of databases. In some embodiments, the database 102B may be embodied by a database having multiple sub-datastores therein, or otherwise utilizing a plurality of sub-repositories. For example, a sub-datastore may include only a specific type of information, for example user information, such that a separate datastore is maintained for each type of stored information. Alternatively, a sub-datastore may be configured for storing a particular subset of stored information, such that, for example, information utilized in communicating with (or providing functionality associated with) external systems is stored separate from information utilized in communicating with (or providing functionality associated with) client devices. Further, it should be appreciated that each datastore, or sub-datastores therein, may include any number of specially configured tables, views, restrictions, and/or other configurations.

Each external system may be configured to communicate with the identification and login system 102 over any number of known communication networks. For example, each of the external systems may be configured to communicate with the identification and login system 102 over the communications network 110. In some embodiments, the communications network 110 includes one or more sub-networks comprising a combination of shared and/or independent networked devices. For example, communications network 110 may be embodied by, or include a sub-network embodied by, a Wi-Fi network, WLAN, PAN, MAN, or other wireless device network. Alternatively or additionally, in some embodiments, the communications network 110 may be embodied by a mobile device network, for example a carrier network, device-specific network, or a combination thereof. In some embodiments, the communications network 110 is embodied by a public network (e.g., the Internet), and in other embodiments the communications network 110 is embodied by a private network (e.g., a LAN) or a hybrid of public and private networks (e.g., an internal network with at least one public communication node).

Additionally, the system includes communications network 112 for enabling communication between the identification and login system 102 and the client device 108. The communications network 112 may be embodied by an out-of-band network with respect to the communications network 110. For example, the communications network 112 may be embodied by a mobile device network or device-specific network where the communications network 110 is embodied by a Wi-Fi or other wireless device network with which the client device 108 has an networked connection (e.g., an authenticated connection or otherwise already established connection to communicate via the communications network 110). In an example context where the client device 108 is embodied by a mobile phone (e.g., a smartphone) or other cellular connected device (e.g., a cellular-enabled tablet), the communications network 112 may be embodied by a carrier network associated with the client device 108.

The client device 108 may communicate with the identification and login system 102 via the carrier network, for example embodied by network 112 or a sub-network of network 112, to enable identification of device identification information associated with the client device 108. For example, the device identification information may be identified based on the transmission from the client device 108 to the identification and login system 102 via the communications network 112 using one or more DAA processes, such as a header enrichment process. In this regard, the carrier network embodies an out-of-band network with respect to one or more other networks with which the client device is configured to communicate (e.g., communications network 110) and/or other sub-networks associated with the network 106. The out-of-band nature of the networked connection enables device identification information to be identified using an out-of-band identification process, so as to prevent channel-based cyber-attacks and ensure verifiability of the device identification information received by the identification and login system 102. In some embodiments, the identification and login system 102 may include and/or communicate with a particular networked device of the carrier network, for example embodied by communications network 112, that serves as an end-point for packet header enrichment via the carrier network. In other embodiments, the network 112 may be embodied by any number of known networks configurations including a networked device configured to perform an out-of-band identification process based on a request transmitted from the client device 108, and forward identified device identification information to the identification and login system 102.

It should be appreciated that, in some embodiments, the client device 108 is configured to switch communicating between utilizing a first communications network (e.g., a wireless device network, for example embodied by communications network 110) and a second communications network (e.g., a mobile device network, for example embodied by communications network 112). In some such embodiments, the client device 108 may be configured to enable such network switching at an application level, such that each executed software application (for example) is enabled to select whether to use a wireless device network or mobile device network. In other embodiments, the client device 108 may be configured such that each executed software application utilizes a primary connection (e.g., whichever network a user has selected for use). The client device 108 may be configured in such a manner based on the operating system and/or other specific firmware configurations installed to the client device 108.

### Example Apparatuses of the Present Disclosure

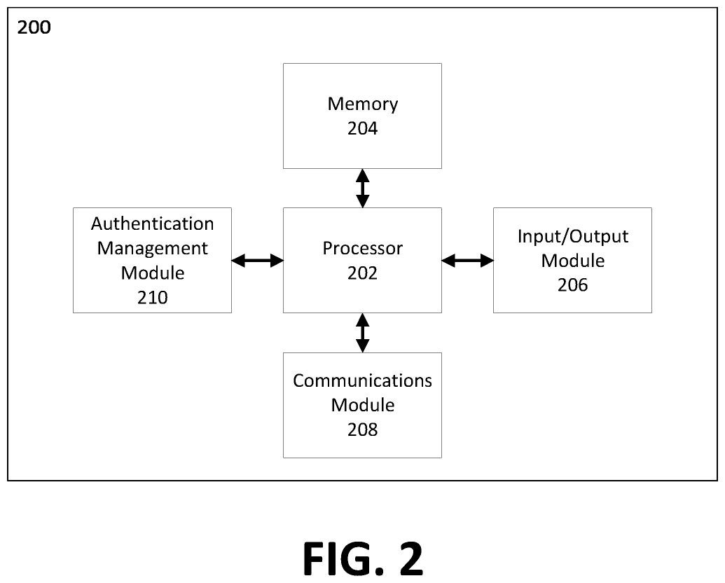

The identification and login system may be embodied in any of a myriad of ways. In some embodiments, the identification and login system 102 is embodied by one or more computing systems, such as the apparatus 200 depicted in FIG. 2. The apparatus 200 includes a processor 202, a memory 204, an input/output module 206, a communications module 208, and an authentication management module. The apparatus 200 may be configured, using one or more of the components 202, 204, 206, 208, and/or 210, to execute the operations described herein.

Although the components are described with respect to functional limitations, it should be understood that the particular implementations necessarily include the use of particular hardware. It should also be understood that certain of the components described herein may include similar or common hardware. For example, two sets of components, for example two sets of circuitry or modules, may both leverage use of the same processor(s), network interface(s), storage medium(s), or the like to perform their associated functions, such that duplicate hardware is not required for each set of components. The use of the terms “circuitry” and “module” as used herein with respect to components of the apparatus 200 should therefore be understood to include particular hardware configured to perform the functions associated with the particular circuitry or module as described herein.

The term “circuitry” and “module” should be understood broadly to include hardware and, in some embodiments, software for configuring the hardware. For example, in some embodiments, “circuitry” or “module” may include processing circuitry, storage media, network interfaces, input/output devices, and the like. In some embodiments, other elements of the apparatus 200 may provide or supplement the functionality of another particular module. For example, the processor 202 may provide processing functionality, the memory 204 may provide storage functionality, the communications module 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus 200. The memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the apparatus 200 to carry out various functions in accordance with example embodiments of the present disclosure.

The processor 202 may be embodied in a number of different ways and may, for example, include one or more processing devices configured to perform independently. Additionally or alternatively, the processor 202 may include one or more processors configured in tandem via a bus to enable independent execution of instructions, pipelining, and/or multithreading. The use of the term “processor” and the term “processing circuitry” generally may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

As just one example, the processor 202 may be configured to identify a network architecture and/or determine a cybersecurity threat set associated with the network architecture. Based on the cybersecurity threat and/or network architecture, the processor 202 may be configured to receive requests data object(s) (e.g., an authentication request data object and/or services identity request data object), process the request data object(s), and generate and/or transmit a response. In an example context, the processor 202, alone or in conjunction with one or more other modules of the apparatus 200, receive an authentication request data object, identify device identification information, retrieve a permissioned device information data object, compare the device identification information with the permissioned device information data object, identify access credentials, and transmit authentication information data object including the access credentials and/or device identification information. In another example context, the processor 202, alone or in conjunction with one or more other modules of the apparatus 200, is configured to receive an authentication request data object from a client device, identify device identification information based on the authentication request data object, receive a services identity request data object from the external system, and transmit an authentication information data object comprising the device identification information and/or access credentials to the external system.

In some embodiments, the apparatus 200 may include input/output module 206 that may, in turn, be in communication with processor 202 to provide output to the user and, in some embodiments, to receive an indication of a user interaction (e.g., user input). The input/output module 206 may comprise one or more user interface(s) (e.g., a device monitoring interface) and may include a display that may comprise the interface(s) rendered as a web user interface, an application interface, a client device, a backend system, or the like. In some embodiments, the input/output module 206 may also include a keyboard, a mouse, a joystick, a touch screen, touch areas, soft keys, a microphone, a speaker, or other input/output mechanisms. The processor 202 and/or input/output module 206 comprising the processor may be configured to control one or more functions of one or more user interface elements through computer program instructions (e.g., software and/or firmware) stored on a memory accessible to the processor (e.g., memory 304, and/or the like).

The communications module 208 may be any means such as a device or circuitry embodied in either hardware or a combination of hardware and software that is configured to receive data from and/or transmit data to a network, circuitry, module, and/or any other device in communication with the apparatus 200. In this regard, the communications module 208 may include, for example, a network interface for enabling communications with one or more wired or wireless communication network(s). For example, the communications module 308 may include one or more network interface card(s), antenna(s), bus(es), switch(es), router(s), modem(s), and supporting hardware and/or software, or any other device suitable for enabling communications via one or more communication network(s). Additionally or alternatively, the communications module 208 may include circuitry for interacting with the antenna(s) and/or other hardware or software to cause transmission of signals via the antenna(s) or to handle receipt of signals received via the antenna(s).

The authentication management module 210 includes hardware, software, or a combination thereof, configured to support functionality of an identification and login system 102. The authentication management module 210 may utilize processing circuitry, such as the processor 202, to perform these actions. The authentication management module 210 may include hardware, software, and/or a combination thereof, configured to, alone or in conjunction with one or more other modules of the apparatus 200, receive one or more request data object(s), for example from a client device and/or external system, and to transmit authentication information data object(s) in response to such received request data object(s). Additionally or alternatively, in some embodiments, authentication management module 210 includes software, hardware, or a combination thereof, to identify device identification information based on a authentication request data object received from a client device. For example, the authentication management module 210 may include hardware, software, or a combination thereof, to identify the device identification information through communications with a trusted third-party system, such as a networked device of a carrier network or a networked service system. Additionally or alternatively, in some embodiments, the authentication management module 210 includes hardware, software, or a combination thereof, to transmit authentication identification information to the client device and/or external system based on the received authentication request data object. For example, the authentication management module 210 may be configured to generate an authentication information data object including the device identification information for the client device and transmit the authentication information data object to the external system for further processing. Alternatively or additionally, the authentication management module 210 may be configured using hardware, software, or a combination thereof, to compare the device identification information with a permissioned device information data object, identify corresponding access credentials, and generate an authentication information data object including the access credentials for transmission to the client device.

Further, in some embodiments, the authentication management module 210 includes hardware, software, or a combination thereof, to add to and/or remove from a permissioned device information data object. For example, the authentication management module 210 may be configured to receive device identification information for including in a permissioned device information data object and update the permissioned device information data object to include the device identification information. Alternatively or additionally, the authentication management module 210 may be configured to receive a permission removal request data object associated with removal device identification information, and update the permissioned device information data object to remove the removal device identification information.

Further, in some embodiments, the authentication management module 210 includes hardware, software, or a combination thereof, to maintain updates for access credentials associated with one or more external system(s). For example, the authentication management module 210 may be configured to identify updated access credentials in response to a detected, received, or otherwise identified credential update event. The authentication management module 210 may be configured to store the updated access credentials, and/or associated information (e.g., effective time data) received from an external system such that the updated access credentials are retrievable associated with the external system. Alternatively or additionally, the authentication management module 210 may be configured to transmit the updated access credentials to one or more connected client devices, for example connected client devices communicable with the apparatus 200 and that have previously requested and received access credentials for the associated external system. In some such embodiments, the authentication management module 210 includes hardware, software, or a combination thereof to receive credential update request data object(s) from one or more connected client device(s) to provide the updated access credentials to the connected client devices.

It should be appreciated that the authentication management module 210 may be embodied in a myriad of ways. For example, in some embodiments, the authentication management module 210 may include a separate processor, specially configured field programmable gate array (FPGA) or a specially programmed application specific integrated circuit (ASIC). In some embodiments, one or more of the modules may perform some, or all, of the functionality described associated with another component of the apparatus 200. For example, in some embodiments, the authentication management module 210 is embodied by a combination of modules, for example a combination of the processor 202, memory 204, and/or communications module 208, such that processing circuitry is provided to perform the operations described above with respect to a combination of each of these modules.

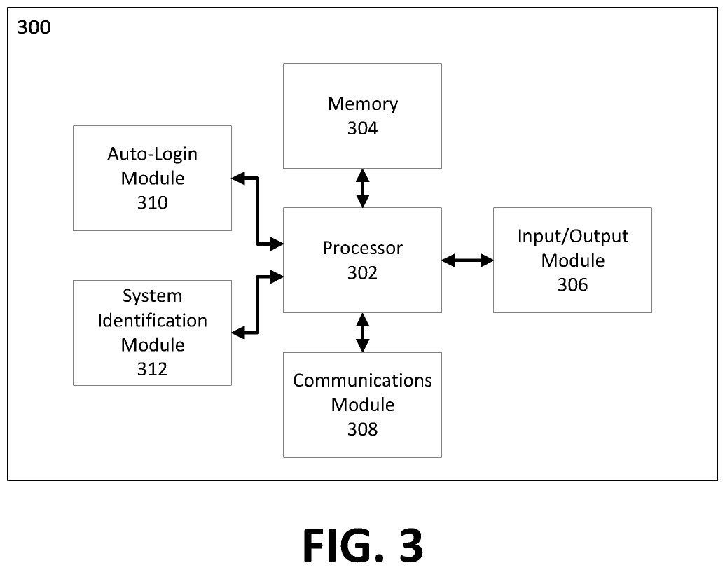

One or more of the client devices 108 may be embodied by one or more computing systems, apparatuses, devices, or the like, for example apparatus 300 depicted in FIG. 3. As illustrated in FIG. 3, the apparatus 300 may include a processor 302, memory 304, input/output module 306, communications module 308, auto-login module 310, and system identification module 312. In some embodiments, one or more modules of the apparatus 300 may provide or supplement the functionality of other modules. For example, the processor 302 may provide processing functionality, the memory 304 may provide storage functionality, the input/output module 306 may provide user interface and/or rendering functionality, the communications module 208 may provide network interface functionality, and the like.

As it relates to the operations described in the present disclosure, the functioning of the processor 302, the memory 304, the input/output module 306, and/or the communications module 308 may be similar to the similarly named components described above with respect to FIG. 2. For the sake of brevity, additional description of the mechanics and functionality associated with these components is omitted. Nonetheless, these device components, whether operating alone or together in any combination, provide the apparatus 300 to facilitate the communication of data between the apparatus 300 and one or more devices and/or systems, such as an identification and login system (such as the identification and login system 102 as depicted in FIG. 1) and/or external system (such as the networked devices 104 and/or networked service systems 106 as depicted in FIG. 1), over one or more communication network(s).

The auto-login module 310 includes hardware, software, or a combination thereof, to configured to support any of the client devices 108 in communications maintaining access credentials and/or transmitting access credentials to an external system to establish and/or maintain an authenticated connection with the external system. The auto-login module 310 may utilize processing circuitry, such as the processor 302, to perform these actions. The auto-login module 310 may be configured to cause transmission of an authentication request data object to an identification and login system, for example through an out-of-band identification process. Additionally or alternatively, the auto-login module 310 may be configured to receive authentication information comprising access credentials from the identification and login system. Further, in some embodiments, the auto-login module 310 may include hardware, software, or a combination thereof, to transmit the access credentials to the external system to establish an authenticated connection, and/or store the access credentials for use in re-establishing an authenticated connection when needed. Additionally or alternatively, in some embodiments, the auto-login module 310 may include hardware, software, or a combination thereof, to receive updated access credentials from the identification and login system, for example automatically and/or in response to a request generated and/or transmitted by the apparatus 300 utilizing the auto-login module 310. The auto-login module 310 may be configured to store the updated access credentials in addition to current access credentials, and/or to retransmit the updated access credentials and/or current access credentials in a circumstance where an interruption of the authenticated connection is detected. In some such circumstances, the auto-login module 310 may be configured to replace the current access credentials with the updated access credentials upon acceptance of the updated access credentials by the external system.

It should be appreciated that the auto-login module 310 may be embodied in a myriad of ways. For example, in some embodiments, auto-login module 310 may include a separate processor, specially configured FPGA, or a specially programmed ASIC. It should also be appreciated that all or some of the information discussed herein can be based on data that is received, generated, and/or maintained by one or more components of the apparatus 300.

The system identification module 312 includes hardware, software, or a combination thereof, to configured to support the client device 108 in detecting an external system and/or transmitting corresponding request data object(s) to a detected external system. The system identification module 312 may utilize processing circuitry, such as the processor 302, to perform these actions. The system identification module 312 may be configured to detect an external system associated with an unestablished authenticated connection, and/or cause transmission of an authentication request data object in response to detecting the external system associated with the unestablished authenticated connection. For example, the system identification module 312 may include hardware, software, or a combination thereof, to detect a Wi-Fi network with which an authenticated connection has not yet been established. Alternatively or additionally, in some embodiments, the system identification module 312 includes hardware, software, or a combination thereof to detect device location data and determine the device location data is within a geographic boundary defined by external system area data corresponding to a particular external system. Further, in some embodiments, the system identification module 312 includes hardware, software, or a combination thereof to cause transmission of the authentication request data object in response to detecting the device location data is within the geographic boundary. Additionally or alternatively, the system identification module 312 may include hardware, software, or a combination thereof, to transmit one or more services request data object(s) to an external system in response to detecting the external system and/or associated device location data within the geographic boundary. In this regard, the system identification module 312 may be configured to provide functionality associated with detecting external systems and/or associated data, and transmitting one or more requests in response to such detecting steps to initiate an automatic authentication and/or login process for the external system via the identification and login system.

It should be appreciated that the system identification module 312 may be embodied in a myriad of ways. For example, in some embodiments, system identification module 312 may include a separate processor, specially configured FPGA, or a specially programmed ASIC. It should also be appreciated that all or some of the information discussed herein can be based on data that is received, generated, and/or maintained by one or more components of the apparatus 300.

It should also be appreciated that, in at least some embodiments, one or more of the modules 302-312 may be combined. Alternatively or additionally, in some embodiments, one or more of the modules may perform some, or all, of the functionality described associated with another component. For example, in some embodiments, the modules 310, 312, and/or 302 may be combined such that processing circuitry is provided to perform the operations described above with respect to each of these modules.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware, and/or firmware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus' circuitry to produce a machine, such that the computer, processor, or other programmable circuitry that execute the code on the machine creates the means for implementing various functions, including those described herein.

The computing systems described herein can include client devices and server devices. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiments or of what may be claimed, but rather as description of features specific to particular embodiments of this disclosure. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

Thus, particular embodiments of the subject matter have been described, and will be described below. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Example System Data Flow

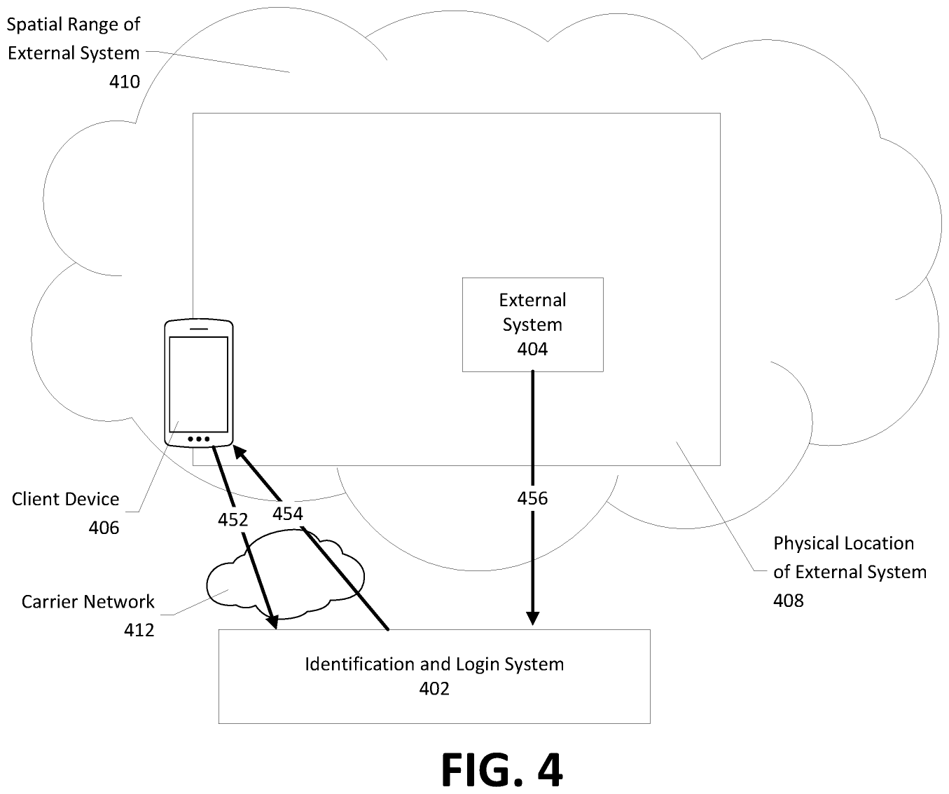

FIG. 4 illustrates an example data flow diagram of an example system in accordance with example embodiments of the present disclosure. Specifically, FIG. 4 illustrates example data flow between an identification and login system 402, external system 404, and client device 406. The external system 404 may be located at a particular physical location 408. The external system 404 and identification and login system 402 may communicate via a particular communications network, for example a public communications network such as the Internet. The client device 406 and identification and login system 402 may communicate via a second communications network, such as the carrier network 412. Additionally or alternatively, the client device 406 may establish a networked connection, via the identification and login system 402, with the external system 404 for accessing functionality provided by the external system 406 (e.g., network functionality, networked service functionality, or the like).

The external system 404 may be located within a particular physical location 408. The physical location of the external system 408 may be represented by a physical marker, building, or the like. In an example context, the physical location of the external system 408 may be embodied by a store location, defined property area, geofenced location, or the like. Additionally or alternatively, in some example contexts, for example where the external system 404 represents a networked device for providing network connectivity functionality to a client device, the external system 404 is associated with a spatial range 410. The spatial range of the external system 410 may represent the signal range for the external system 404, for example, such that client devices 404 are configured to detect the external system 404 when within the spatial range of the external system 410. In some embodiments, the spatial range of the external system 410 is configurable by an administrator of the external system 404, for example via directly interfacing with the external system 404 and/or through an admin device communicable with the external system 404. In some such contexts, the external system 404 is configured such that the spatial range of the external system 410 approximately corresponds to the boundaries of the physical location of the external system 408.

The client device 406 may be configured to communicate with the external system 404 for establishing an authenticated connection via the identification and login system. When an authenticated connection is established, the user of the client device 406 may utilize the client device 406 to access functionality provided by the external system 404. In a particular context where the external system 404 is a networked device, for example, the client device 406 may communicate with the external system 404 via an authenticated connection as an access point to a wireless device network (e.g., a Wi-Fi network). The client device 406 may communicate with the identification and login system 402 to receive access credentials to initiate the authenticated connection, for example by forwarding the access credentials to the external system 404. Additionally or alternatively, the client device 406 may communicate with identification and login system 402 to maintain access credentials (e.g., receive updated access credentials for re-establishing the authenticated connection with the external system 404).

In an example embodiment, the system interacts for initiating and/or maintaining an authenticated connection between the client device 406 and the external system 404 through the steps 452-456. At step 452, for example, the client device 406 is configured to detect it is within the spatial range of the external system 410. The client device 406 may detect it is within the spatial range of the external system 410 using any of a myriad of system-detection methodologies, including, without limitation, by detecting a network name, SSID, or other external system identifier associated with the external system 404. Additionally or alternatively, the client device 406 may detect device location data associated with the client device 406 is within the physical location of the external system 408. The client device 406 may similarly detect it is within the physical location of the external system 408 using any of a myriad of location-detection methodologies, including, without limitation, by using GPS location, Wi-Fi signatures, cell tower triangulation, Bluetooth signal proximity, or the like.

Upon such location and/or system detection, at step 452, the client device 406 transmits at least one data packet to the identification and login system 402 to cause the identification and login system 402 to identify device identification information associated with the client device 406. For example, the client device 406 may transmit one or more data object(s) (e.g., a request data object, such as a HTTP GET request or POST request), to the identification and login system 402. The data object(s) may include no client-device submitted content data or may include content data used by the identification and login system 402 for authentication purposes (e.g., a location data, available network data, and/or the like). In other embodiments, any customized data packets are transmitted from the client device 406 to the identification and login system 402.

The transmitted data object, for example an authentication request data object, may be configured for use by the identification and login system 402 to identify the device identification information associated with the client device 406 through one or more trusted third-party systems. For example, as illustrated, the client device 406 may transmit the authentication request data object through the carrier network 412. The identification and login system 402 may cooperate with one or more networked devices of the carrier network 412 to identify the device identification information associated with the client device 406. In an example context, for example where the client device 406 is embodied by a smartphone or other mobile device, the identification and login system 402 may cooperate with the carrier network 412 to identify a mobile phone number associated with the client device 406 (in plaintext or hashed format), or another unique identifier associated with a user account linked to the client device 406 (e.g., an account number for a user account used for billing purposes). In this regard, the carrier network 412 may include a networked device (or a plurality of networked devices) configured to perform an out-of-band identification process to identify the device identification information associated with an authentication request data object transmitted from the client device 406. The networked device (or plurality of networked devices) may further be configured to forward the device identification information to the identification and login system along with, injected into, and/or otherwise associated with the authentication request data object from the client device 406. In other embodiments, the identification and login system 402 is configured to communicate with another trusted third-party system to identify and/or forward the device identification information using the same, and/or an alternative, out-of-band identification process.

At step 454, the identification and login system 402 may determine if the identified device identification information is permissioned to access the external system 404. In some embodiments, the identification and login system is configured to compare the identified device identification information is compared with a permissioned device information data object associated with the external system 404. The permissioned device information data object may be retrieved and/or received by the identification and login system 402 based on information included in the data object received from the client device (e.g., an external system identifier corresponding to the external system to be accessed). In an example context, the permissioned device information data object embodies a white list of mobile phone numbers authorized for accessing the external system 404. If authorized, at step 454, the identification and login system 402 may identify access credentials for accessing the external system 404, and transmit at least the access credentials to the client device 406. It should be appreciated that in some embodiments, access credentials are shared between all client device(s) associated with various device identification information. In other embodiments, the identification and login system 402 retrieves and/or otherwise identifies user-specific access credentials linked to the client device 406 (for example, using the associated device identification information). In some contexts, the access credentials are transmitted in authentication information, which may include other information such as the device identification information, effective time data, and/or the like.

The client device 406 may receive the access credentials (and/or additional information) and utilize this data to initiate an authenticated connection with the external system 404. For example, the client device 406 may be configured to automatically transmit the access credentials to request an authenticated connection. Additionally or alternatively, once connected, the client device 406 may store and/or maintain the access credentials for use in re-establishing the authenticated connection with the external system 404. For example, in a circumstance where the authenticated connection is interrupted, the client device 406 may automatically detect the interruption, retrieve the stored access credentials, and transmit these credentials to the external system to re-establish the authenticated connection.

Once connected, the system may continue to communicate to manage access credential updates. For example, at step 456, the external system 404 may initiate a credentials update event, for example by transmitting a particular request data object to the identification and login system 402. In an example context, the external system 404 transmits at least updated access credentials to be used for initiating/establishing and/or re-establishing an authenticated connection with the external system 404. The identification and login system 402 may store the updated access credentials as current access credentials to be transmitted to client device(s) that subsequently request access, for example replacing previous access credentials. Additionally or alternatively, external system 404 may transmit additional information, such as effective time data associated with the updated access credentials, for storage and/or utilization by the identification and login system.

The identification and login system 402, at step 456, may then transmit the updated access credentials, and/or associated information such as effective time data, to a connected client device set associated with the external system 404. For example, identification and login system 402 may maintain a connected client device set as client devices successfully are authenticated and/or otherwise verified, such that the client device 406 may have been added to the set at or before step 454. The identification and login system 402 may automatically transmit the updated access credentials to cause the client device 406 to store at least the updated access credentials, and/or associated information, corresponding to the external system 404. In some embodiments, the client device 406 is configured to store the updated access credentials in addition to current access credentials. In some such embodiments, the client device 406 may alternate between the current access credentials and the updated access credentials when re-establishing an authenticated connection with the external system 404, and subsequently replace the current access credentials with the updated access credentials once the updated access credentials are accepted by the external system 404 as valid.

In this regard, the authenticated connection between the client device 406 and external system 404 is established and maintained automatically. The identity of the client device 406 is highly trusted due to cooperation between the identification and login system 402 and a trusted third-party system, such as a carrier network 412. The trusted third-party system may utilize a highly-secure out-of-band identification process, for example reliance on the methodologies utilized by a carrier network to bill customers for wireless data usage via the carrier network. Further, the system enables the authenticated connection may be updated to utilize updated access credentials without a noticeable interruption to the user associated with the client device 406, and requiring no specific user action to facilitate the update. Additionally or alternatively still, the access credentials utilized by the external system 404 may be computationally complex (for example, randomly generated alphanumeric sequences at or above a pre-defined length of characters) because the system does not rely on the user to remember and/or otherwise track such access credentials.

It should be appreciated that, in other embodiments, the components of the system may communicate in addition to or alternative to the data flow illustrated in FIG. 4. For example, additional communications between the client device 406 and/or identification and login system 402 may occur as the client device 406 navigates throughout the physical location of the external system 408. Alternatively or additionally, the identification and login system 402 may communicate with the client device 406 to periodically re-identify and/or verify device identification information associated with the client device to further improve system security (e.g., to prevent a malicious actor from improperly stealing an application state from the client device, and transferring the stolen application state for use on a malicious third-party client device). Additionally or alternatively still, the identification and login system 402 may communicate with the client device 406 to perform device tracking functionality and/or other associated functionality. Additionally or alternatively still, the external system 404 and identification and login system 402 may communicate to distribute additional updated access credentials (for example, at pre-defined timestamp intervals, or in response to certain detected data and/or events). As the system continues to function, no user authentication may be required, but may be utilized to request the initial connection (at least once), or to improve the user experience by providing some user-initiated control where desired.

Example Operations Performed by Example Identification and Login System

Having described an example data flow, specific example flowcharts including various operations performed by apparatuses, devices, and/or sub-systems of the above described systems will now be discussed. It should be appreciated that each of the flowcharts depicts an example computer-implemented process that may be performed by one, or more, of the above described apparatuses, systems, or devices. In regard to the below flowcharts, one or more of the depicted blocks may be optional in some, or all, embodiments. Optional blocks are depicted with broken (dashed) lines.

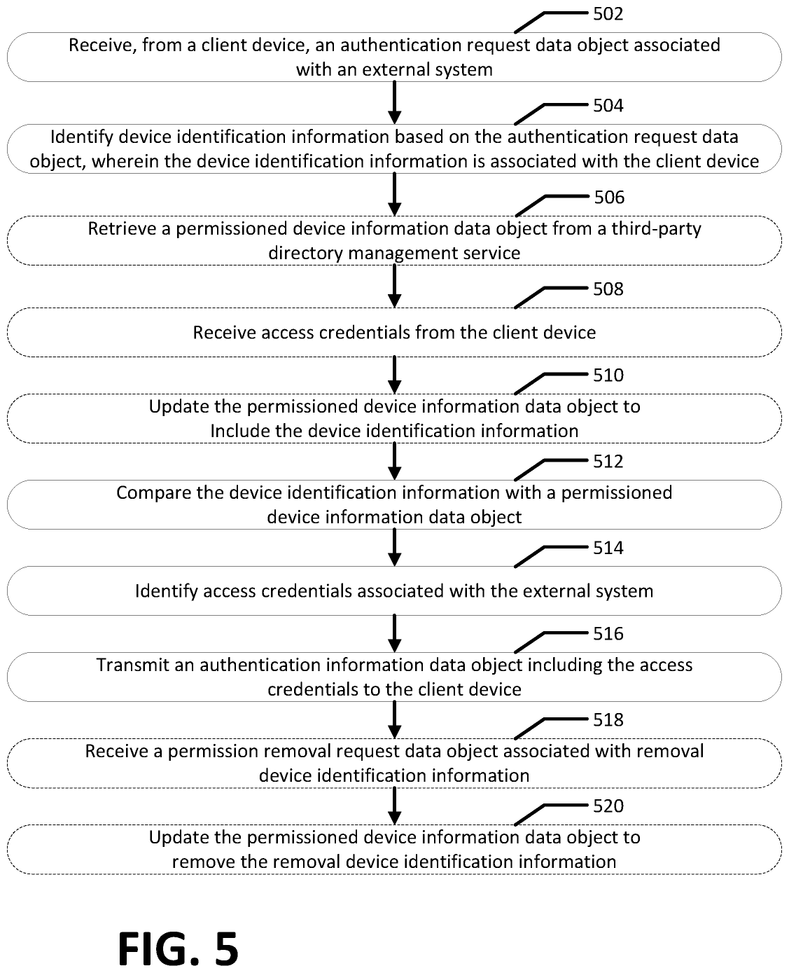

It should be appreciated that the particular operations depicted and described below with respect to FIGS. 5-10 illustrate specific operations or steps that may be performed in a particular process. Further, the process may be implemented by computer hardware, software, or a combination thereof, of a system, apparatus, device, or the like, as a computer-implemented method. In other embodiments, the various blocks may represent blocks capable of being performed by an apparatus, device, or system. For example, computer-coded instructions may be specially programmed for performing the various operations depicted and stored for execution by an apparatus, for example in one or more memory devices for execution by one or more processors. In other embodiments, computer program code capable of executing the operations depicted by the various blocks may be stored to one or more non-transitory memory devices associated with a computer program product or other computer readable storage medium.

FIG. 5 illustrates an example process for secure access credential management in accordance with an example embodiment of the present disclosure. The example process illustrated may be performed by an identification and login system, for example an identification and login system 102 embodied by the apparatus 200. In some embodiments, the apparatus 200 may be configured to communicate with one or more other devices, systems, apparatuses, or the like, for receiving and/or transmitting the information described with respect to the example process. For example, the apparatus 200 may communicate with one or more client device(s) and/or one or more external system(s).

At block 502, the apparatus 200 includes means, such as authentication management module 210, communications module 208, processor 202, and/or the like, or a combination thereof, configured to receive, from a client device, an authentication request data object associated with an external system. In this regard, the authentication request data object may represent a user request to automatically receive access credentials associated with the particular external system. In some such embodiments, the authentication request data object includes an external system identifier linked to the external system. The external system identifier may embody a system-defined identifier, a network identifier (e.g., an IP address), a serial number, or the like. The authentication request data object, additionally or alternatively, may include client device information, such as one or more client device identifiers that uniquely identify the client device that originated the request data object.

In some embodiments, the apparatus 200 further receives supplemental information associated with the authentication request data object. In some embodiments, the authentication request data object includes the supplemental information transmitted via the client device for use in identifying and/or authenticating a device identity or user identity associated with the client device. In other embodiments, the apparatus 200 receives the supplemental information associated with the authentication request data object over a second networked connection. For example, the apparatus 200 may receive the authentication request data object over a mobile device network associated with the client device (e.g., a carrier network), and the supplemental information over a wireless data network (e.g., a Wi-Fi network) with which the client device is connected. The supplemental information may include any of a myriad of user-submitted, and/or client-device detected information for use in one or more verification, identification, and/or security processes performed by the apparatus 200 or an associated system, such as a trusted third-party system. For example, the supplemental information may include a user-submitted username and/or password for use in an out-of-band identification process, additional verification process, and/or security process. In a particular example context, the supplemental information is provided via a cable provider, for example where the supplemental information is used by the apparatus 200 for additional security or other operations.

At block 504, the apparatus 200 includes means, such as authentication management module 210, communications module 208, processor 202, and/or the like, or a combination thereof, configured to identify device identification information based on the authentication request data object. In some embodiments, the device identification information is identified by parsing the device identification information from the authentication request, for example where the device identification information was injected into the authentication request data object by a trusted third-party system using an out-of-band identification process (e.g., using a header enrichment process performed by a carrier network over which the authentication request data object was transmitted).

In some embodiments, the device identification information is associated with the client device, for example such that the device identification information is trusted to serve as a proxy for identification of the client device and/or an associated user. For example, in a particular example context, the device identification information represents a mobile phone number associated with the client device. In this regard, the device identification information is associated with a mobile device that is often kept in close proximity to the owner, and secured by one or more authentication processes (e.g., a passcode, password, biometric confirmation(s), and/or the like). In this regard, access to the client device serves as a proxy for the identity of the user associated with the client device without requiring subsequent authentication.

In some embodiments, the apparatus 200 communicates with one or more trusted third-party system(s) to identify the device identification information. For example, the apparatus 200 may forward the authentication request data object, and/or other received information (for example received supplemental information) to the trusted third-party system, to cause the trusted third-party system to perform an out-of-band identification process to identify the device identification information, and forward the device identification information to the apparatus 200 in response. In some such embodiments, in this regard, the apparatus 200 is configured to identify the device identification information based on the authentication request data object through cooperation with one or more trusted third-party system(s) configured to perform a trusted out-of-band identification process. The device identification information is identified via a highly-secure process, and thus is trusted to be associated with the client device and can be used for subsequent authentication and other operations.

At optional block 506, the apparatus 200 includes means, such as authentication management module 210, communications module 208, processor 202, and/or the like, or a combination thereof, configured to retrieve a permissioned device information data object from a third-party management service. In some such contexts, the third-party management service is configured to maintain a permissioned device information data object that includes device identification information, credentials, and/or other profile information associated with users, user accounts and/or client devices associated with particular users. For example, the third-party management service may represent a system, device, or application that stores at least mobile phone numbers associated with users of a particular organization or other entity (e.g., employees of a company, group, or the like). The stored device identification information (e.g., mobile phone numbers) may be those permissioned to access one or more external systems associated with the organization, for example a particular network or a networked service system. The third-party management service may be maintained by an administrator user permissioned to add to and/or remove from the permissioned device information data object associated with the external system. An non-limiting example of a third-party management service includes Active Directory™ offered by Microsoft Corp.

Additionally or alternatively, in other embodiments, the apparatus 200 is configured to maintain a permissioned device information data object without assistance and/or communication with a directory management service. For example, in some embodiments, an administrator user may access the apparatus 200 through an administrator device to add to and/or remove from the permissioned device information data object. Additionally or alternatively still, the apparatus 200 may be configured to manage the permissioned device information data object associated with an external system automatically as client devices communicate with the apparatus 200.

In this regard, at optional block 508, the apparatus 200 includes means, such as authentication management module 210, communications module 208, processor 202, and/or the like, or a combination thereof, configured to receive access credentials from the client device. In some embodiments, the apparatus 200 receives the access credentials included in the earlier received authentication request data object, and receives the access credentials by parsing the access credentials from the authentication request data object. In other embodiments, the apparatus 200 receives the access credentials in a second transmission (e.g., a transmission of supplemental information) associated with the authentication request data object). The access credentials received from the client device may represent current access credentials for use in initiating an authenticated connection with the external system. As such, receiving the access credentials from the client device indicates the client device and/or user associated with the client device has obtained the access credentials through another means. For example, in an example context, a user may read a network password serving as access credentials to a particular networked device (e.g., an external system) from a board within a public restaurant, bar, coffee shop, store, or other public Wi-Fi-enabled location, or may request such access credentials from an administrator (e.g., an employee of a public coffee shop).

At optional block 510, the apparatus 200 includes means, such as authentication management module 210, processor 202, and/or the like, or a combination thereof, configured to update a permissioned device information data object to include the device identification information associated with the client device. In this regard, the apparatus 200 may update the permissioned data object associated with the external system to include the device identification information, indicating that the client device is permissioned to establish and/or maintain an authenticated connection with the external system. In some such contexts, the apparatus 200 is configured to update the permissioned device information data object associated with the external system to include the device identification information automatically in response to receiving, from the client device, the access credentials associated with the external system. In so doing, the apparatus 200 is configured to enable automatic addition of device identification information to the permissioned device information data object for such client devices without particular permissioning performed by an administrator.

At block 512, the apparatus 200 includes means, such as authentication management module 210, communications module 208, processor 202, and/or the like, or a combination thereof, configured to compare the device identification information with a permissioned device information data object. The permissioned device information data object may have been retrieved at a previous block, such as at the optional block 506 and/or 510, or may be retrieved at block 512 for comparison. The apparatus 200 may compare the device identification information with the permissioned device information data object to determine whether the device identification information is located within the permissioned device information data object. In some embodiments, in a circumstance where the apparatus 200 compares the device identification information with the permissioned device information data object and determines the device identification information is not within the permissioned device information data object, the apparatus 200 may generate and/or transmit an authentication failed response to the client device indicating the client device is not permissioned to access the external system requested. Alternatively, in some such embodiments, in a circumstance where the apparatus 200 compares the device identification information with the permissioned device information and determines the device identification information is within the permissioned device information data object, the apparatus 200 may continue to a subsequent block.

At block 514, the apparatus 200 includes means, such as authentication management module 210, communications module 208, processor 202, and/or the like, or a combination thereof, configured to identify access credentials associated with the external system. In some embodiments, the apparatus 200 is configured to retrieve access credentials associated with the external system (for example, using an external system identifier) to identify the access credentials. In other embodiments, the apparatus 200 identifies access credentials included in or otherwise associated with the permissioned device information data object. In yet other embodiments, the apparatus 200 communicates with the external system to identify the access credentials, for example by receiving the current access credentials in response to a request transmitted to the external system to retrieve them.

In some embodiments, the access credentials are configured to enable access to the external system for various user accounts and/or client devices. For example, in an example context where the external system is a networked device (e.g., a network access point for a Wi-Fi network), the access credentials may be embodied by a network password used by all users to initiate an authenticated connection with the external system. In this regard, the same current access credentials may be identified for each device identification information. In other embodiments, the apparatus 200 is configured to identify access credentials specifically tied to a particular user account or device identification information. For example, in an example context where the external system is a networked service system configured to provide a networked service, the access credentials may be a user-specific password, or combination of username and password. In some such embodiments, the apparatus 200 identifies the access credentials based on the device identification information and external system (e.g., based on a corresponding external system identifier). For example, the apparatus 200 may identify a particular username and password combination associated with the client device corresponding to the device identification information.

Additionally, in some embodiments, the apparatus 200 may be configured to identify and/or retrieve additional information associated with the identified access credentials. For example, in some embodiments, the apparatus 200 is configured to identify effective time data associated with the identified access credentials. The effective time data may represent a timestamp interval during which the corresponding access credentials may be used to initiate and/or re-initiate an authenticated connection with the external system. In this regard, after the effective time data elapses, the apparatus 200 may detect and/or receive a credentials update event as described herein, and provide updated access credentials to the client device in a circumstance where the client device remains connected to the apparatus 200 and/or external system.

At block 516, the apparatus 200 includes means, such as authentication management module 210, communications module 208, processor 202, and/or the like, or a combination thereof, configured to transmit, to the client device, an authentication information data object including at least the access credentials. In some embodiments, the apparatus 200 is configured to generate the authentication information data object including at least the access credentials identified at an earlier block. It should be appreciated that, in some embodiments, the authentication information data object includes other information associated with the access credentials, for example effective time data. Additionally or alternatively, in some embodiments, the authentication information data object includes the identified device identification information corresponding to the client device. The authentication information data object may be configured to cause the client device to utilize the access credentials and/or other information within the authentication information data object to initiate an authenticated connection with the external system. Additionally or alternatively, the authentication information data object may be transmitted to the client device for storage, for example to utilize in re-establishing an authenticated connection with the external system.

At optional block 518, the apparatus 200 includes means, such as authentication management module 210, communications module 208, processor 202, and/or the like, or a combination thereof, configured to receive a permission removal request data object, for example from an admin device. The permission removal request data object may include, or otherwise be associated with, removal device identification information to remove from the permissioned device information data object. In an example context, the removal device identification information is associated with an employee that has left an organization associated with the external system. In another example context, the removal device identification information is associated with a client device that has not communicated with the external system for a length of time that exceeds an inactivity threshold. In some embodiments, the permission removal request data object is received directly from the external system, or from an associated admin device associated with an administrator user in control of the external system.

At optional block 520, the apparatus 200 includes means, such as authentication management module 210, communications module 208, processor 202, and/or the like, or a combination thereof, configured to update the permissioned device information data object to remove the removal device identification information. For example, the apparatus 200 may search the permissioned device information data object for a data object including or associated with the removal device identification information. If a data object is located, the data object and/or associated information may be deleted from the permissioned device information data object. In other embodiments, in a circumstance where the data object associated with or including the removal device identification information is located, the data object is marked as not permissioned to indicate that the data object is removed from the permissioned device information data object.

Additionally or alternatively, in some embodiments, the apparatus 200 includes such means to receive a permission addition request data object, for example from an admin device. The permission addition request data object may include, or be associated with additional device identification information to be added to the permissioned device information data object. In some such embodiments, the apparatus 200 includes such means to update the permissioned device information data object to include the additional device identification information. In this respect, the permissioned device information data object may be updated to include newly permissioned device identification information or remove device identification information no longer permissioned to access the external system.

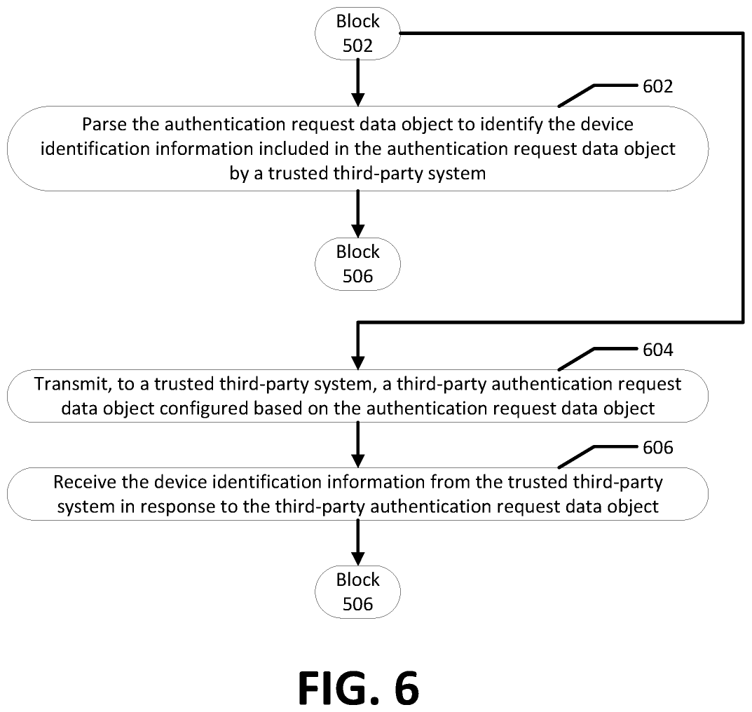

FIG. 6 illustrates additional example operations for secure access credential management, specifically to identify device identification information based on the authentication request data object, in accordance with some example embodiments of the present disclosure. In some embodiments, one or more of the operations depicted with respect to FIG. 6 is/are performed in addition to, or alternative to, the operations depicted with respect to FIG. 5. In some embodiments, the operations depicted are performed by an identification and login system, for example an identification and login system 102 embodied by the apparatus 200.

In some embodiments, the process depicted in FIG. 6 begins at block 602, which may occur after one or more blocks as illustrated in FIG. 5, for example after block 502. At block 602, the apparatus 200 includes means, such as authentication management module 210, communications module 208, processor 202, and/or the like, or a combination thereof, configured to parse the authentication request data object to identify the device identification included in the authentication request data object by a trusted third-party system. In some such embodiments, the trusted third-party system is configured to identify and/or provide the device identification information using an out-of-band identification process. The out-of-band identification process may identify the device identification information using a highly trusted and secure methodology controlled by the trusted third-party system. In one example context, the trusted third-party system is configured to perform a header enrichment process to identify device identification information, for example a mobile phone number, associated with the client device as the authentication request data object is processed and/or forwarded by the trusted third-party system (e.g., a networked device of a mobile device network). Further, in some example contexts, the trusted third-party system is configured to inject the device identification information into the authentication request data object before continuing to process and/or otherwise forward the authentication request data object to the apparatus 200. In this regard, the apparatus 200 is configured to identify the device identification information via cooperation with the trusted third-party system.

In some embodiments, after block 602, flow returns to one or more of the blocks depicted with respect to FIG. 5. For example, in some embodiments, flow continues to optional block 506 as illustrated in FIG. 5. Alternatively or additionally, in some embodiments, flow continues to block 512 as illustrated in FIG. 5.

Alternatively, in some embodiments, the process depicted in FIG. 6 begins at block 604, which may occur after one or more blocks as illustrated in FIG. 5, for example after block 502. At block 604, the apparatus 200 includes means, such as authentication management module 210, communications module 208, processor 202, and/or the like, or a combination thereof, configured to transmit, to a trusted third-party system, a third-party authentication request data object configured based on the authentication request data object. In this regard, the third-party authentication request data object is configured to cause the trusted third-party system to perform one or more out-of-band identification process. In some embodiments, the third-party authentication request data object includes, is embodied by, or is otherwise linked to the authentication request data object received from the client device. Additionally or alternatively, in some embodiments, the third-party authentication request data object includes one or more client device identifiers associated with the client device. The third-party authentication request data object may be used by the trusted third-party system to identify device identification information associated with the client device that transmitted the authentication request data object.

At block 604, the apparatus 200 includes means, such as authentication management module 210, communications module 208, processor 202, and/or the like, or a combination thereof, configured to receive the device identification information from the trusted third-party system in response to the third-party authentication request data object. The device identification information may be received from the trusted third-party system as response information to the third-party authentication request data object. The received device identification information may be highly trusted as associated with the client device. For example, the device identification information may have been identified through a secure login process, eSIM/SIM technologies, and/or other secure processes for identification and/or billing.

In some embodiments, after block 606, flow returns to one or more of the blocks depicted with respect to FIG. 5. For example, in some embodiments, flow continues to optional block 506 as illustrated in FIG. 5. Alternatively or additionally, in some embodiments, flow continues to block 512 as illustrated in FIG. 5.

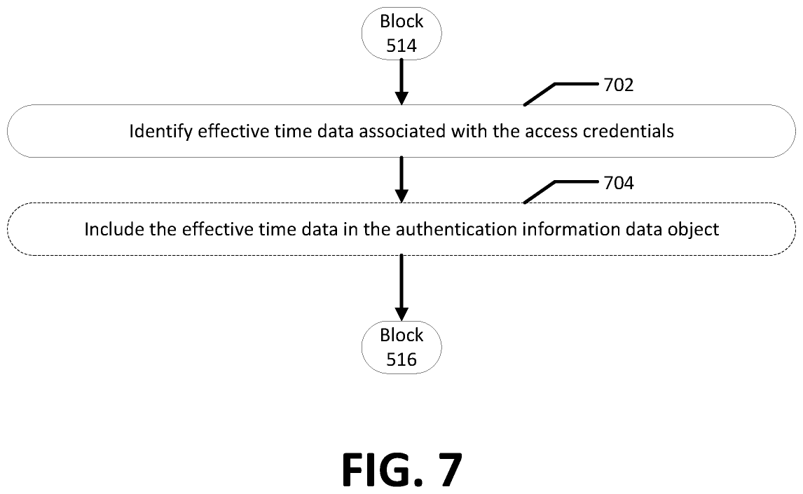

FIG. 7 illustrates additional example operations for secure access credential management, specifically to configure authentication information data object for transmission to a client device, in accordance with some example embodiments of the present disclosure. In some embodiments, one or more of the operations depicted with respect to FIG. 7 is/are performed in addition to, or alternative to, the operations depicted with respect to FIG. 5. In some embodiments, the operations depicted are performed by an identification and login system, for example an identification and login system 102 embodied by the apparatus 200.

In some embodiments, the process depicted in FIG. 7 begins at block 702, which may occur after one or more blocks as illustrated in FIG. 5, for example after block 514. At block 702, the apparatus 200 includes means, such as authentication management module 210, communications module 208, processor 202, and/or the like, or a combination thereof, configured to identify effective time data associated with the access credentials. In some embodiments, the apparatus 200 is configured to retrieve stored effective time data associated with the authentication data. In other embodiments, the apparatus 200 may communicate with the external system to identify the effective time data. For example, the apparatus 200 may receive the effective time data together with access credentials from the external system.

The effective time data may be utilized by the apparatus 200 for one or more purposes. In some embodiments, the apparatus 200 stores the effective time data for detecting and/or otherwise identifying a credential update event associated with current access credentials. Additionally or alternatively, the effective time data may be transmitted to a client device for storing together with and/or associated with access credentials. In this regard, at optional block 704, the apparatus 200 includes means, such as authentication management module 210, communications module 208, processor 202, and/or the like, or a combination thereof, configured to include the effective time data in the authentication information data object. The authentication information data object may additionally include access credentials, device identification information, and/or any combination thereof. The authentication information data object may be configured for transmission to a client device, for example for utilization and/or storage by the client device. For example, the client device may store the effective time data to determine when updated access credentials are to be used to establish and/or re-establish an authenticated connection with the corresponding external system.

In some embodiments, after block 704, flow returns to one or more of the blocks depicted with respect to FIG. 5. For example, in some embodiments, flow continues to optional block 506 as illustrated in FIG. 5. Alternatively or additionally, in some embodiments, flow continues to block 516 as illustrated in FIG. 5.

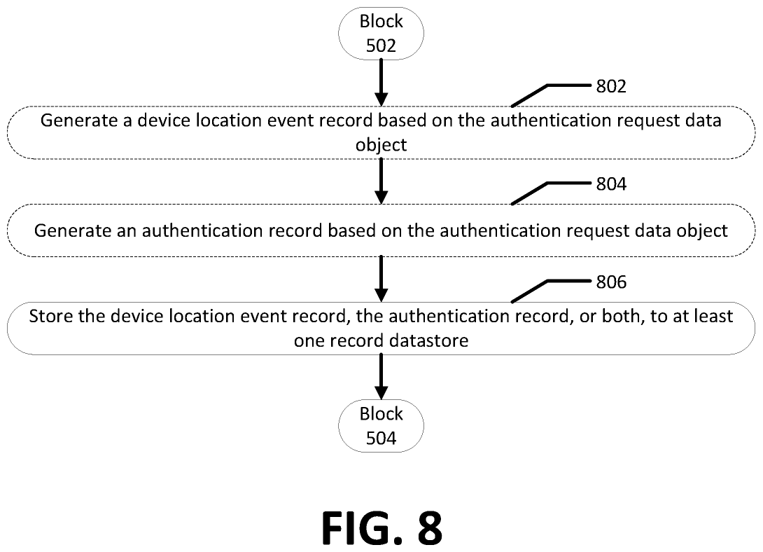

FIG. 8 illustrates additional example operations for secure access credential management, specifically to store one or more records associated with a received request data object, in accordance with some example embodiments of the present disclosure. In some embodiments, one or more of the operations depicted with respect to FIG. 8 is/are performed in addition to, or alternative to, the operations depicted with respect to FIG. 5. In some embodiments, the operations depicted are performed by an identification and login system, for example an identification and login system 102 embodied by the apparatus 200.

In some embodiments, the process depicted in FIG. 8 begins at block 802, which may occur after one or more blocks as illustrated in FIG. 5, for example after block 502. At block 802, the apparatus 200 includes means, such as authentication management module 210, processor 202, and/or the like, or a combination thereof, configured to generate a device location event record based on the authentication request data object. In some contexts, the device location event record indicates the client device has entered a particular geographic boundary and/or is located at a particular location. An example device location event record includes at least device identification information associated with the client device. Alternatively or additionally, in some example contexts, the device location event record includes location data received from the client device, such as location data included in a received authentication request data object. Additionally or alternatively still, the apparatus 200 may identify and/or receive metadata to include in the device location event record, for example timestamp data associated with the detected location or the like. In some embodiments, the apparatus 200 generates the device location event record as a structured data object including one or more portions of data parsed from the authentication request data object and/or identified using information from the authentication request data object. In a particular example context, several low-range routers are distributed throughout a store location, each low-range router embodying an external system. As a client device moves throughout the external systems, it is configured to establish and/or maintain an authenticated connection through the apparatus 200, and the apparatus 200 stores the device location event records for the movement of the client device.

At block 804, the apparatus 200 includes means, such as authentication management module 210, processor 202, and/or the like, or a combination thereof, configured to generate an authentication record based on the authentication request data object. In some contexts, the authentication record summarizes and/or otherwise indicates that a particular client device requested authentication associated with an external system. An example authentication record includes at least device identification information associated with the client device that transmitted the authentication request data object. Additionally or alternatively, in some example contexts, the authentication record includes an external system identifier associated with the external system linked to the authentication request data object. Alternatively or additionally still, in some example contexts, the authentication record includes an authentication success indicator that designates whether the apparatus 200 determined the identified device identification information is permissioned to access the requested external system (for example, through comparing the device identification information and a permissioned device information data object). Additionally or alternatively still, the apparatus 200 may similarly identify and/or receive metadata to include in the authentication record, for example timestamp data associated with the authentication or the like. In some embodiments, the apparatus 200 generates the authentication record as a structured data object including one or more portions of data parsed from the authentication request data object and/or identified using information from the authentication request data object.

At block 806, the apparatus 200 includes means, such as authentication management module 210, processor 202, and/or the like, or a combination thereof, configured to store the device location event record, the authentication record, or both, to at least one record datastore. In some embodiments, the apparatus 200 stores the device location event record, the authentication record, or both, to a single record datastore configured for storing multiple record types. In other embodiments, the apparatus stores the device location event record to a first datastore configured for storing device location event records, and stores the authentication record to a second datastore configured for storing device location event records. In some such embodiments, the first datastore and second datastore are embodied by sub-databases and/or tables of a master datastore maintained by the apparatus 200.

The at least one record datastore may be embodied in a myriad of ways. In some embodiments, for example, the at least one record datastore includes at least one specially configured database. The database(s) may be embodied by a local database, a cloud or remote database, or other known database implementation. Such databases may similarly be implemented by any known hardware implementation, software implementation, or a combination thereof. In other embodiments, the at least one record datastore includes one or more blockchains configured for storing the records. In a particular embodiment, for example, the at least one record datastore includes a public, hybrid, or private blockchain configured for storing device location event record(s) and/or the same blockchain or a second blockchain configured for storing authentication record(s).

Using the at least one record datastore, the apparatus 200 is configured to enable auditing of authentication requests and/or other functionality associated with authentication or client device locations. For example in some embodiments, based on the authentication records stored to the at least one record datastore, the apparatus 200 is configured to audit authentication attempts and/or occurrences associated with a particular client device. Additionally or alternatively, in some embodiments, the apparatus 200 is configured to track client device entrance into a geo-fenced boundary and/or exit from a geo-fenced boundary based on the device location event records. Alternatively or additionally still, in some embodiments, the apparatus 200 is configured to utilize the device location event records and/or authentication records to enable tracking of a client device within the geographic boundary associated with a linked external system. For example, the apparatus 200 each device location event record and/or authentication record, or a combination thereof, may indicate a client device location at the time that authentication was requested (for example, to complete a transaction), and whether the authentication was successful.

In this regard, the apparatus 200 or an associated user associated with the external system may utilize such records to identify various information associated with a client device and thus with user behavior of an associated user. For example, the apparatus 200 and/or a user in communication with the apparatus 200 may determine the time of arrival and/or departure from a particular geographic boundary associated with the external system (e.g., to and/or from a store location). In other embodiments where more detailed device location event records are stored, the apparatus 200 and/or a user in communication with the apparatus 200 may determine more precise user navigation and/or actions within a particular geographic boundary associated with the external system. For example, the records stored by the apparatus 200 may be retrieved, parsed, and/or otherwise analyzed to determine that the client device was located in a particular area associated with a particular product, service, point of interest, or other information, for example such that the external system or another correlated system may perform one or more actions based on these determinations. In one example context, for example, the external system and/or a correlated system may communicate with the apparatus 200 to retrieve the stored device location event records and/or authentication records and determine that a user spent 20 minutes looking at shoes, then left a store location without purchasing shoes, and may choose to send a coupon to the user for the shoes if purchased within a particular timeframe (e.g., within the next 3 days).

In some embodiments, after block 806, flow returns to one or more of the blocks depicted with respect to FIG. 5. For example, in some embodiments, flow continues to block 504 as illustrated in FIG. 5.

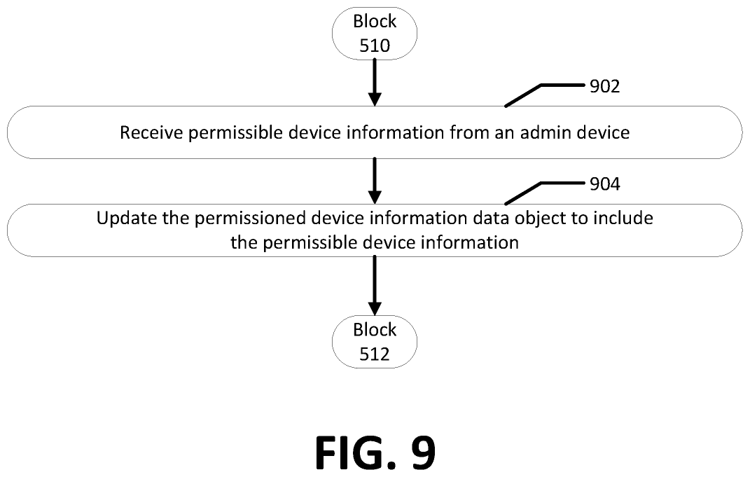

FIG. 9 illustrates additional example operations for secure access credential management, specifically to configure a permissioned device information data object, in accordance with some example embodiments of the present disclosure. In some embodiments, one or more of the operations depicted with respect to FIG. 9 is/are performed in addition to, or alternative to, the operations depicted with respect to FIG. 5. In some embodiments, the operations depicted are performed by an identification and login system, for example an identification and login system 102 embodied by the apparatus 200.

In some embodiments, the process depicted in FIG. 9 begins at block 902, which may occur after one or more blocks as illustrated in FIG. 5, for example after block 510. At block 902, the apparatus 200 includes means, such as authentication management module 210, communications module 208, processor 202, and/or the like, or a combination thereof, configured to receive permissible device information from the client device or an admin device. In an example context, the permissible device information represents particular client device information authorized and/or otherwise permissioned to access a particular external system. For example, the permissible device information may be associated with a client device linked to an employee of an organization, or may be associated with a client device located within a particular geographic area associated with a public external system (e.g., a public Wi-Fi system).

In some such embodiments, the admin device is associated with a particular external system or communicates through the corresponding external system, such that the permissible device information may be linked to a permissioned device information data object associated with the corresponding external system. For example, a user may have authenticated user credentials with the external system via the admin device to access such functionality. The user, via the admin device, may utilize the admin device to request device identification information be added to the permissioned device information data object linked to the external system, and/or to request device identification information be removed from the permissioned device information data object linked to the external system.

At block 904, the apparatus 200 includes means, such as authentication management module 210, processor 202, and/or the like, or a combination thereof, configured to update the permissioned device information data object to include the permissible device information. In some such embodiments, the permissible device information is appended to the permissioned device information data object. In other embodiments, the permissible device information is otherwise added to the permissioned device information data object in a structured manner (e.g., sorted by a particular desired sorting methodology).

In this regard, the user may, via the admin device, configure the permissioned device information data object for a particular external system to include specific device identification information. As new client devices are to be granted access to the external system (for example, new client devices associated with new employees of an organization, or users that have requested access to a public network or networked service), permissible device information corresponding to the new client device may be transmitted for including in the permissioned device information data object. Additionally or alternatively, as discussed above with respect to FIG. 5, in some embodiments an admin device may be utilized to remove permissions from such client devices (for example, for client devices associated with ex-employees of an organization, or that have left a particular geographic area associated with a public network or networked service). Alternatively or additionally, the permissioned device information data object is added to by an admin device as described above with respect to FIG. 9, and is maintained automatically thereafter such that device identification information is automatically removed from the permissioned device information data object according to one or more defined rules (e.g., authorization terminates after a predetermined number of days, authorization terminates after inactivity is detected for a predetermined time interval, or the like).

In some embodiments, after block 904, flow returns to one or more of the blocks depicted with respect to FIG. 5. For example, in some embodiments, flow continues to block 512 as illustrated in FIG. 5.

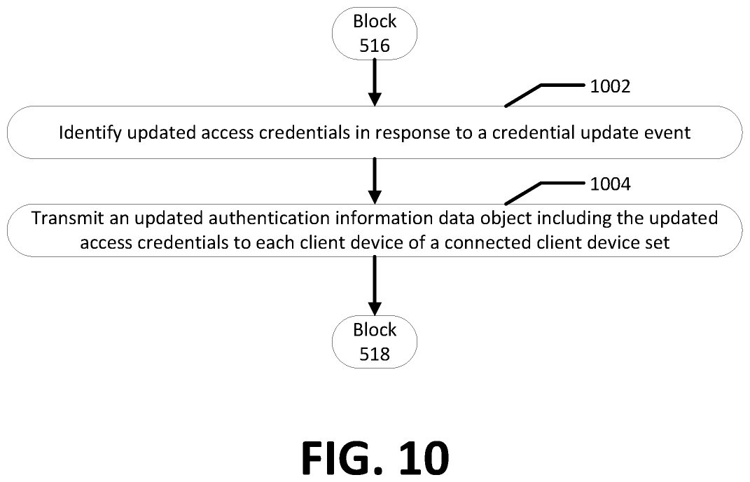

FIG. 10 illustrates additional example operations for secure access credential management, specifically to automatically update access credentials for one or more client device(s), in accordance with some example embodiments of the present disclosure. In some embodiments, one or more of the operations depicted with respect to FIG. 10 is/are performed in addition to, or alternative to, the operations depicted with respect to FIG. 5. In some embodiments, the operations depicted are performed by an identification and login system, for example an identification and login system 102 embodied by the apparatus 200.

In some embodiments, the process depicted in FIG. 10 begins at block 1002, which may occur after one or more blocks as illustrated in FIG. 5, for example after block 516. At block 1002, the apparatus 200 includes means, such as authentication management module 210, communications module 208, processor 202, and/or the like, or a combination thereof, configured to identify updated access credentials in response to a credential update event. In some embodiments, the credential update event is detected by the system. For example, in an example context, the apparatus 200 is configured to determine that effective time data associated with access credentials has expired. Alternatively or additionally, in some embodiments, the credential update event is initiated by communications with the external system. For example, an administrator user may initiate a credential update event through communication with the external system, and/or the external system may automatically detect a credential update event. In some such contexts, the apparatus 200 is configured to receive a transmission from the external system, where the transmission represents the credential update event.

In some embodiments, the apparatus 200 is configured to identify the updated access credentials based on a transmission from the external system. For example, data packets received from the external system may include the updated access credentials generated and/or retrieved by the external system. In some such embodiments, the apparatus 200 is configured to parse the received transmission to identify the updated access credentials. Additionally or alternatively, the apparatus 200 may parse the received transmission to identify additional information associated with the updated access credentials, such as effective time data. In other embodiments, to identify the updated access credentials, the apparatus 200 is configured to generate the updated access credentials in response to the credential update event. In some such embodiments, the apparatus 200 is further configured to generate additional information associated with the updated access credentials (for example, effective time data).

In some embodiments, the apparatus 200 is configured to store the updated access credentials associated with the external system linked to the credential update event. For example, in this regard, the apparatus 200 may replace current access credentials associated with the external system with the updated access credentials. As new authentication request data objects are received from client devices, the apparatus 200 may, after authenticating the client device, distribute the updated access credentials for use in establishing an authenticated connection between a client device and the external system. The updated access credentials may be stored in a short-term memory, long-term memory (e.g., a database or other permanent storage), or a combination thereof.

At block 1004, the apparatus 200 includes means, such as authentication management module 210, communications module 208, processor 202, and/or the like, or a combination thereof, configured to transmit an updated authentication information data object including the updated access credentials to each client device of a connected device set. In some such embodiments, the apparatus 200 maintains a connected client device set that includes one or more device identification information, client device identifiers, or other communication information for transmitting data to client devices that previously were authenticated and/or received access credentials from the apparatus 200 for a particular external system. In other embodiments, each connected client device in the connected client device set is configured to transmit another request data object to the apparatus 200 to receive the updated authentication information. For example, in some embodiments, at block 1004 the apparatus 200 is configured to receive a second authentication request data object from the client device and transmit the updated authentication information data object including the updated access credentials to the client device in response to the second authentication request data object. The apparatus 200 may receive such a second authentication request data object for each connected client device. It should be appreciated that, in some embodiments, the updated authentication information data object includes additional information associated with the updated access credentials. For example, the updated authentication information data object may additionally include updated effective time data associated with the updated access credentials, for example such that the client device may request further updated access credentials at a later time.

In this regard, the apparatus 200 is configured to enable automatic access credential updating for the client device(s) of the connected client device set. Either automatically or in response to a subsequently received transmission received from a connected client device, the apparatus 200 provides the updated authentication information data object for use in establishing and/or re-establishing an authenticated connection with the external system linked to the updated access credentials. Additionally or alternatively, additional information in the updated authentication information data object (e.g., effective time data) may be utilized by each connected client device to configure and/or transmit subsequent requests for updated access credentials.

In some embodiments, after block 1004, flow returns to one or more of the blocks depicted with respect to FIG. 5. For example, in some embodiments, flow continues to optional block 518 as illustrated in FIG. 5. Alternatively or additionally, in some embodiments, flow ends after block 1004.

Example Operations Performed by Example Identification and Login System

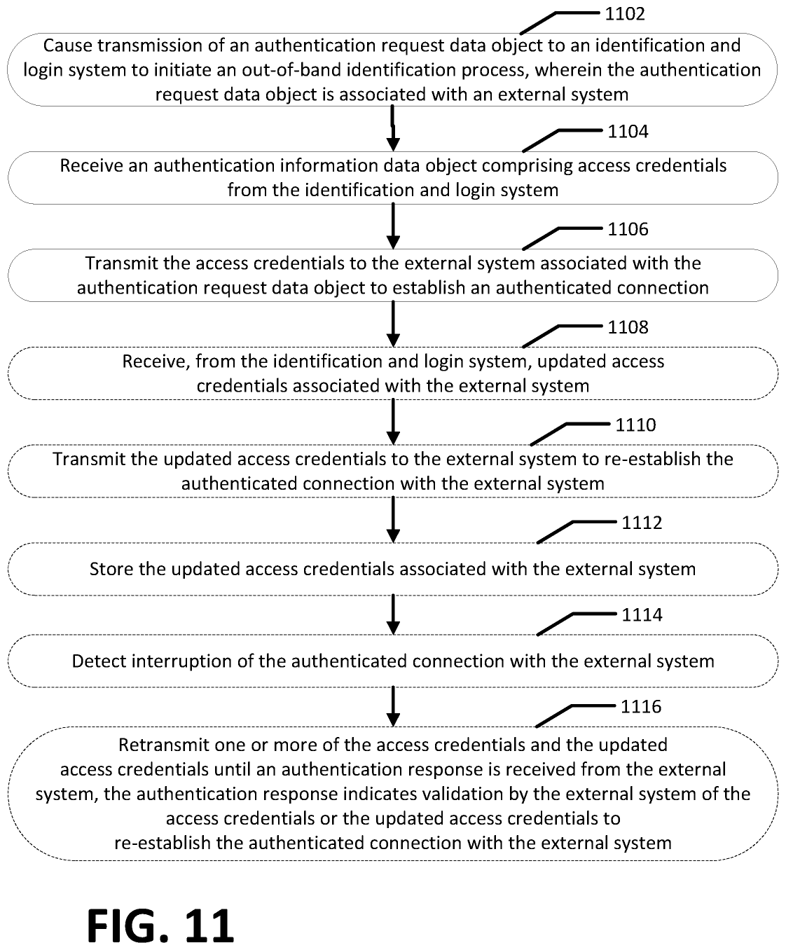

It should be appreciated that the particular operations depicted and described below with respect to FIGS. 11-17 illustrate specific operations or steps that may be performed in a particular process. Further, the process may be implemented by computer hardware, software, or a combination thereof, of a system, apparatus, device, or the like, as a computer-implemented method. In other embodiments, the various blocks may represent blocks capable of being performed by an apparatus, device, or system. For example, computer-coded instructions may be specially programmed for performing the various operations depicted and stored for execution by an apparatus, for example in one or more memory devices for execution by one or more processors. In other embodiments, computer program code capable of executing the operations depicted by the various blocks may be stored to one or more non-transitory memory devices associated with a computer program product or other computer readable storage medium.

FIG. 11 illustrates an example process for secure access credential management in accordance with an example embodiment of the present disclosure. The example process illustrated may be performed by a specially configured client device, for example a client device 108 embodied by the apparatus 300. In some embodiments, the apparatus 300 may be configured to communicate with one or more other devices, systems, apparatuses, or the like, for receiving and/or transmitting the information described with respect to the example process. For example, the apparatus 300 may communicate with an identification and login system and/or one or more external system(s).

At block 1102, the apparatus 300 includes means, such as auto-login module 310, system identification module 312, input/output module 306, communications module 308, processor 302, and/or the like, or a combination thereof, configured to cause transmission of an authentication request data object to an identification and login system to initiate an out-of-band identification process. In some such embodiments, the authentication request data object is associated with an external system. For example, in an example context, the authentication request data object includes an external system identifier associated with the external system to be accessed. In other embodiments, the identification and login system is only configured associated with one external system, such that all authentication request data objects are associated with the corresponding one external system.

In some embodiments, the apparatus 300 is configured to cause transmission of the authentication request data object in response to user engagement with the apparatus 300. The apparatus 300 may be configured to receive user engagement data indicating a user desire to access functionality associated with the external system. For example, in some embodiments, a user interacts with the apparatus 300, through one or more rendered interfaces, to indicate a request to access a wireless device network or networked service functionality. In some such embodiments, the external system is identified based on the user interaction data.

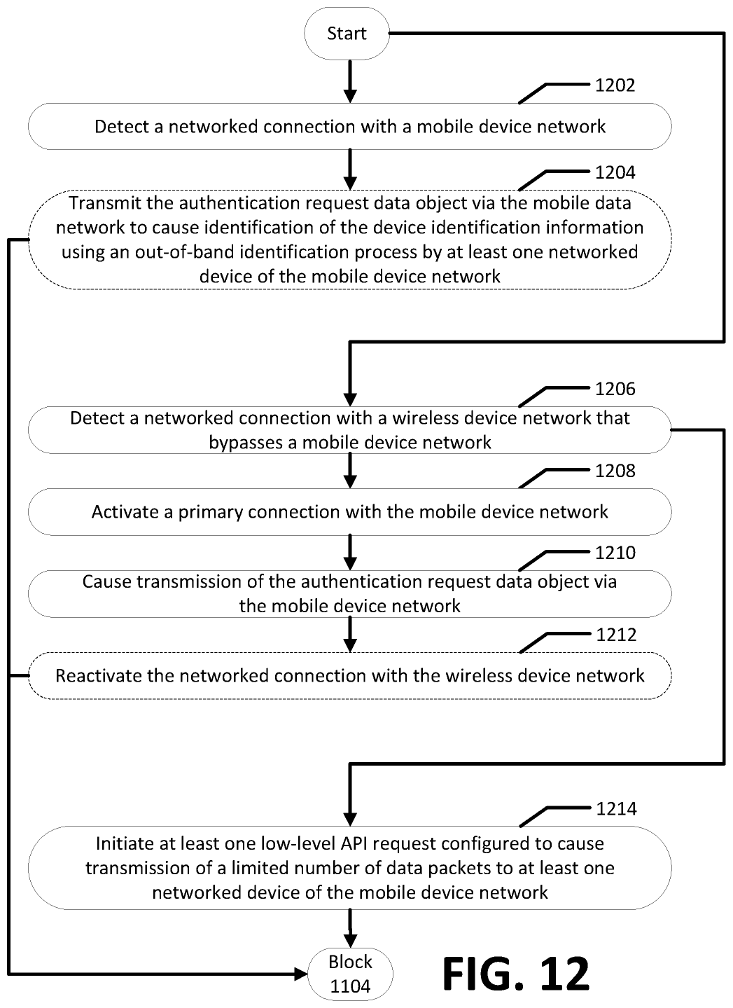

The apparatus 300 may be configured to cause transmission of the authentication request data object to the identification and login system to initiate the out-of-band identification process using any of a myriad of methodologies. For example, in some embodiments, the apparatus 300 is configured to cause the transmission using one or more of the methodologies described below with respect to FIG. 12. It should be appreciated that, in other embodiments, traditional networking communications may be used to cause transmission of the authentication request data object to the identification and login system, and to cause the identification and login system to transmit and/or forward subsequent information to one or more trusted third-party system(s) to initiate the out-of-band identification process via the trusted third party system(s).

At block 1104, the apparatus 300 includes means, such as auto-login module 310, communications module 308, processor 302, and/or the like, or a combination thereof, configured to receive, from the identification and login system, an authentication information data object comprising at least access credentials. The apparatus 300 may receive the authentication information data object in response to the identification and login system successfully identifying device identification information associated with the client device, and authenticating that the device identification information is permissioned to access the external system, for example as described herein. In some embodiments, the authentication information data object includes additional information, for example effective time data associated with the access credentials, a session identifier and/or other identifier to be used in subsequent requests (e.g., to retrieve updated access credentials without subsequent authentication), device identification information identified by the identification and login system, metadata, and/or the like.

In some embodiments, the apparatus 300 is configured to store the authentication information data object and/or a portion thereof. For example, in some embodiments, the apparatus 300 stores the received access credentials and/or stores associated effective time data. The apparatus 300 may retrieve and/or utilize the stored information to establish and/or re-establish an authenticated connection with a corresponding external system. Additionally or alternatively, the apparatus 300 may retrieve and/or utilize the stored information to communicate with the identification and login system to receive updated access credentials. For example, the apparatus 300 may store effective time data for access credentials and utilize the effective time data to determine a credential update event (e.g., expiration of the effective time data) and, in response to the determination, transmit one or more data packets to the identification and login system to receive updated access credentials.

At block 1106, the apparatus 300 includes means, such as auto-login module 310, input/output module 306, communications module 308, processor 302, and/or the like, or a combination thereof, configured to transmit the access credentials to the external system associated with the authentication request data object to establish an authenticated connection with the external system. In some such embodiments, the authenticated connection enables the apparatus 300 to request functionality provided by the external system. For example, in an example context, the external system is a networked device or wireless access point associated with a wireless device network (e.g., a public Wi-Fi network), such that the authenticated connection enables the apparatus 300 to leverage the external system for network connectivity. In another example context, the external system is a networked service system, such that the authenticated connection enables the apparatus 300 to leverage the external system for application specific functionality provided by the external system (e.g., an internal application service associated with an organization). In this regard, in some embodiments, the authenticated connection is facilitated by traditional cryptographic and/or session management methodologies in response to the external system successfully validating the access credentials.

At optional block 1108, the apparatus 300 includes means, such as auto-login module 310, communications module 308, processor 302, and/or the like, or a combination thereof, configured to receive, from the identification and login system, updated access credentials associated with the external system. In some embodiments, the updated access credentials are received in an updated authentication information data object received from the identification and login system. The updated authentication information data object may include additional information associated with the updated access credentials, for example effective time data associated with the access credentials, identified device identification information associated with the updated access credentials, metadata, and/or a combination thereof.

In some embodiments, the apparatus 300 receives the updated access credentials automatically from the identification and login system. For example, in some such embodiments, the identification and login system is configured to receive and/or identify a credential update event, and transmit the updated access credentials to the apparatus 300 in response to the credential update event. In other embodiments, the apparatus 300 is configured to receive the updated access credentials in response to a transmission from the apparatus 300 to the identification and login system. In an example context, the apparatus 300 is configured to identify a credential update event, and transmit one or more data packets to the identification and login system in response to the identified credential update event. For example, in some embodiments, the apparatus 300 identifies the credential update event based on determining that effective time data for current access credentials (e.g., the access credentials received at block 1104) has expired. Alternatively, in some embodiments, the apparatus 300 identifies the credential update event based on detecting an interruption of the authenticated connection with the external system, and/or identifying that the current access credentials were not accepted by the external system.

At optional block 1110, the apparatus 300 includes means, such as auto-login module 310, system identification module 312, communications module 308, processor 302, and/or the like, or a combination thereof, configured to transmit the updated access credentials to the external system to re-establish the authenticated connection with the external system. In some such embodiments, the updated access credentials represent new information accepted by the external system for establishing such authenticated connections. In an example context, the previous access credentials (e.g., the access credentials received at block 1104) may no longer be accepted by the external system. Upon transmitting the updated access credentials to re-establish the connection, the apparatus 300 may receive cryptographic and/or other information from the external system used to maintain the authenticated connection until another access credential update occurs.

At optional block 1112, the apparatus 300 includes means, such as auto-login module 310, system identification module 312, communications module 308, processor 302, and/or the like, or a combination thereof, configured to store the updated access credentials associated with the external system. In some embodiments, the apparatus 300 stores the updated access credentials as current access credentials (e.g., by replacing the access credentials received at block 1104). For example, in some embodiments, the apparatus 300 stores the updated access credentials as current access credentials where the apparatus 300 previously transmitted the updated access credentials and received a response indicating the updated access credentials were accepted. In other embodiments, the apparatus 300 is configured to store the updated access credentials in addition to current access credentials.

At optional block 1114, the apparatus 300 includes means, such as auto-login module 310, system identification module 312, communications module 308, processor 302, and/or the like, or a combination thereof, configured to detect interruption of the authenticated connection with the external system. In some such embodiments, the apparatus 300 is configured to detect the interruption by receiving an error from the external system indicating an interruption. Alternatively or additionally, in some embodiments, the apparatus 300 is configured to detect the interruption by determining the external system is unreachable when trying to transmit one or more data packets. Additionally or alternatively, in some such embodiments, the apparatus 300 is configured to detect the interruption using any of a myriad of known error and/or network communications methodologies.

At optional block 1116, the apparatus 300 includes means, such as auto-login module 310, system identification module 312, communications module 308, processor 302, and/or the like, or a combination thereof, configured to retransmit one or more of the access credentials and the updated access credentials until an authentication response is received from the external system, where the authentication response indicates validation by the external system of the access credentials or the updated access credentials. The accepted access credentials are utilized to re-establish the authenticated connection with the external system.

In an example context, the access credentials representing current access credentials are accepted, for example where the external system did not yet update its accepted access credentials. Such a circumstance may occur when the authenticated connection between the apparatus 300 and the external system is interrupted for any of a number of temporary device communication interruptions (e.g., poor signal strength, communication timeout, or the like). The apparatus 300 may continue to store the received updated access credentials for use upon updating by the external system. In another example context, the updated access credentials are accepted by the external system, for example where the external system updated its accepted access credentials in response to a credential update event. In this respect, the previous access credentials (e.g., the access credentials received at block 1104) are no longer used for accessing the external system, and thus no longer need to be stored. The apparatus 300 may replace the current access credentials with the updated access credentials (e.g., such that the updated access credentials are used as the new current access credentials). In some such contexts, the apparatus 300 continues to store only the updated access credentials as current access credentials until new updated access credentials are received. In this respect, it should be appreciated that one or more of the optional operations described with respect to blocks 1108-1116 may be repeated any number of times.

In such embodiments, the updated access credentials may be received automatically without subsequent user interaction. As such, security of the external system is enhanced by allowing usage of complex passwords and/or utilizing an increased number of changes for access credentials. However, even with such improved security, the user experience is maintained and not diminished by interruptions and/or unnecessary and consistent user action. Instead, the apparatus 300 requests, receives, and utilizes access credentials automatically and handles updates of access credentials automatically with a non-noticeable connection interruption.

FIG. 12 illustrates additional example operations for secure access credential management, specifically to cause transmission of an authentication request data object to an identification and login system over a desired network (e.g., a mobile device network instead of a wireless data network), in accordance with some example embodiments of the present disclosure. In some embodiments, one or more of the operations depicted with respect to FIG. 12 is/are performed in addition to, or alternative to, the operations depicted with respect to FIG. 11. In some embodiments, the operations depicted are performed by a specially configured client device, for example a specially configured client device 108 embodied by the apparatus 300.

In some embodiments, the process depicted in FIG. 12 begins at block 1202, which may occur after one or more blocks as illustrated in FIG. 11 or may begin the flow. At block 1202, the apparatus 300 includes means, such as auto-login module 310, system identification module 312, communications module 308, processor 302, and/or the like, or a combination thereof, configured to detect a networked connection with a mobile device network. In a particular context, the mobile device network is embodied by a carrier network associated with the apparatus 300 (e.g., a mobile phone carrier). The networked connection with the mobile device network may be maintained through hardware and/or firmware of the apparatus 300, for example in conjunction with the operating system of the apparatus 300. In some embodiments, the apparatus 300 is configured to default to the networked connection with the mobile device network in a circumstance where no networked connection is established between the apparatus 300 and a wireless device network (e.g., a Wi-Fi connection or other wireless connection). In this regard, the apparatus 300 may detect the networked connection with a mobile device network by identifying data indicating that the apparatus 300 does not have a networked connection with any wireless data network.

In some embodiments, the apparatus 300 is configured to detect the networked connection with the mobile device network via hardware, software, firmware, or a combination thereof. For example, in some embodiments, the operating system of the apparatus 300 is configured to enable such detection. In other embodiments, a software application executed via the apparatus 300 is configured to enable such detection (e.g., directly or through communication with the operating system). In either such circumstances, the apparatus 300 may be configured to utilize a networking interface and/or other hardware to perform the detection.

At optional block 1204, the apparatus 300 includes means, such as auto-login module 310, communications module 308, processor 302, and/or the like, or a combination thereof, configured to transmit the authentication request data object via the mobile device network to cause identification of the device identification information using an out-of-band identification process by at least one networked device of the mobile device network. For example, in some embodiments, the apparatus 300 is configured to transmit an authentication request data object over the mobile device network. The mobile device network may include one or more specially configured networked devices that perform the out-of-band identification process as the authentication request data object is handled by the networked device. For example, the apparatus 300 may identify a particular URL and/or endpoint associated with the networked device, such that the networked device receives the authentication request data object and forwards it to the identification and login system together with device identification information identified through the out-of-band identification process. In some embodiments, the mobile device network utilizes a plurality of networked devices configured to perform the out-of-band identification process.

In some embodiments, the process depicted in FIG. 12 begins at block 1206, which may occur after one or more blocks as illustrated in FIG. 11 or may begin the flow. At block 1206, the apparatus 300 includes means, such as auto-login module 310, system identification module 312, communications module 308, processor 302, and/or the like, or a combination thereof, configured to detect a networked connection with a wireless device network that bypasses a mobile device network. The networked connection with the wireless device network may be maintained through hardware and/or firmware of the apparatus 300, for example in conjunction with the operating system of the apparatus 300. In some embodiments, the apparatus 300 is configured to utilize the wireless data network as a primary connection by default, such that transmissions are directed via the wireless data network unless otherwise specified. In some embodiments, the apparatus 300 is configured to detect the networked connection with the wireless data network via hardware, software, firmware, or a combination thereof. For example, in some embodiments, the operating system of the apparatus 300 is configured to enable such detection. In other embodiments, a software application executed via the apparatus 300 is configured to enable such detection (e.g., directly or through communication with the operating system). In either such circumstances, the apparatus 300 may be configured to utilize a networking interface and/or other hardware to receive data and/or otherwise perform the detection.

At block 1208, the apparatus 300 includes means, such as auto-login module 310, communications module 308, processor 302, and/or the like, or a combination thereof, configured to activate a primary connection with the mobile device network. In some embodiments, the apparatus 300 is configured to activate the primary connection with the mobile device network via hardware, software, firmware, or a combination thereof. For example, in some embodiments, to activate the primary connection with the mobile device network, the apparatus 300 may deactivate or otherwise temporarily disable the networked connection with the wireless data network. In some such embodiments, the apparatus 300 is configured, via an executed software application, operating system, and/or firmware, to deactivate the networked connection with the wireless data network and activate the mobile device network. In some embodiments, the apparatus 300 activates the mobile device network automatically in response to deactivating the networked connection with the wireless data network.

At block 1210, the apparatus 300 includes means, such as auto-login module 310, communications module 308, processor 302, and/or the like, or a combination thereof, configured to cause transmission of the authentication request data object via the mobile device network. The apparatus 300 may communicate via the primary connection with the mobile device network. For example, in some embodiments, the apparatus 300 is configured to transmit the authentication request data object over the mobile device network to cause initiation of an out-of-band identification process. The mobile device network may include one or more specially configured networked devices that is configured to perform the out-of-band identification process as the authentication request data object is handled by the networked device. For example, the apparatus 300 may identify a particular URL and/or endpoint associated with the networked device, such that the networked device receives the authentication request data object and forwards it to the identification and login system together with device identification information identified through the out-of-band identification process. In some embodiments, the mobile device network utilizes a plurality of networked devices configured to perform the out-of-band identification process.

At optional block 1212, the apparatus 300 includes means, such as auto-login module 310, communications module 308, processor 302, and/or the like, or a combination thereof, configured to reactivate the networked connection with the wireless device network. In some embodiments, the apparatus 300 is configured to reactivate the networked connection with the wireless device network via hardware, software, firmware, or a combination thereof. Alternatively, in some embodiments, the apparatus 300 is configured to activate the networked connection with the wireless data network by deactivating the primary connection with the mobile device network via hardware, software, firmware, or a combination thereof. For example, in some embodiments, to activate the primary connection with the mobile device network, the apparatus 300 may deactivate or otherwise temporarily disable the networked connection with the wireless data network. For example, in an example context, the apparatus 300 is configured to reactivate the networked connection with the wireless device network using one or more API calls performed by an executed software application in conjunction with the operating system of the apparatus 300. For example, the apparatus 300 may store configuration data associated with the networked connection with the wireless data network upon deactivation, and retrieve and/or utilize the stored configuration data to reactivate the networked connection.

Returning to block 1206, in some embodiments, flow continues to block 1214. For example, in some embodiments, flow continues to block 1208 in embodiments configured to enable application-layer manipulation of networked connections (e.g., application-level control of a networked connection with a wireless data network, or default networked connection with a mobile device network), and flow continues to block 1214 in embodiments not configured to enable such a configuration. For example, in some embodiments, flow continues to block 1214 where networked connections are user-controlled (e.g., the application cannot deactivate a networked connection with a wireless data network that bypasses a mobile device network).

At block 1214, the apparatus 300 includes means, such as auto-login module 310, communications module 308, processor 302, and/or the like, or a combination thereof, configured to initiate at least one low-level API request configured to cause transmission of a limited number of data packets to at least one networked device of the mobile device network. In some embodiments, the data packets embody the authentication request data object, or a portion thereof. The limited number of data packets may be utilized by the at least one networked device to perform an out-of-band identification process. Device identification information may be identified based on the data packets, for example device identification information associated with the apparatus 300. In this regard, the low-level API request(s) may enable the out-of-band identification process performed by a networked device of the mobile device network (e.g., a header enrichment process performed by a carrier network) without interrupting or disabling the networked connection with the wireless data network. In some such embodiments, simultaneous to the data packets transmitted through the low-level API call(s), the apparatus 300 may transmit the authentication request data object to the identification and login system via the networked connection with the wireless data network.

In some embodiments, after block 1204, block 1212, or block 1214, flow returns to one or more of the blocks depicted with respect to FIG. 11. For example, in some embodiments, flow continues to block 1104 as illustrated in FIG. 11.

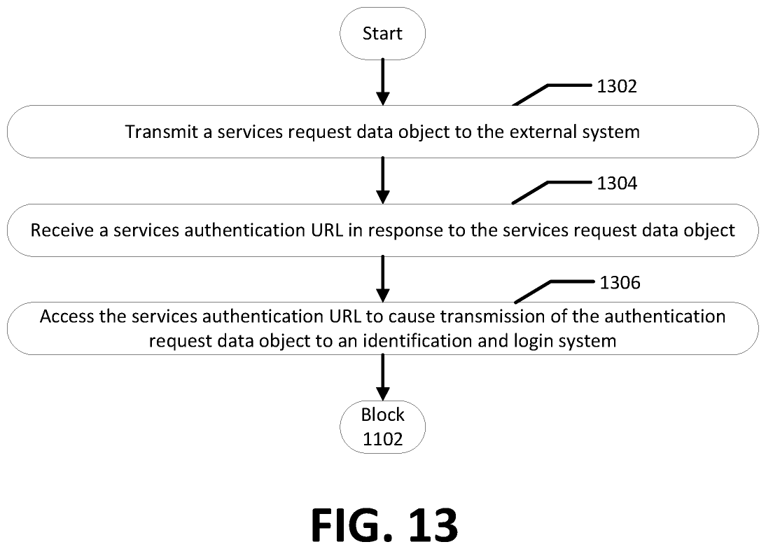

FIG. 13 illustrates additional example operations for secure access credential management, in accordance with some example embodiments of the present disclosure. In some embodiments, one or more of the operations depicted with respect to FIG. 13 is/are performed in addition to, or alternative to, the operations depicted with respect to FIG. 11. In some embodiments, the operations depicted are performed by a specially configured client device, for example a specially configured client device 108 embodied by the apparatus 300.

In some embodiments, the process depicted in FIG. 13 begins at block 1302, which may occur after one or more blocks as illustrated in FIG. 11 or may begin the flow. At block 1302, the apparatus 300 includes means, such as auto-login module 310, system identification module 312, input/output module 306, communications module 308, processor 302, and/or the like, or a combination thereof, configured to transmit a services request data object to the external system. In some embodiments, for example, the apparatus 300 is configured to present one or more interfaces for a user to select an external system with which the user would like to initiate an authenticated connection. In some such embodiments, the apparatus 300 is configured to receive user interaction data indicative of a user desire to initiate an authenticated connection with the external system. The apparatus 300 may generate and/or transmit the services request data object to the external system in response to the user interaction data.

The services request data object may be specially configured to indicate that the apparatus 300 is requesting to initiate and/or otherwise establish an authenticated connection with the external system. In some embodiments, the services request data object includes data indicating particular functionality and/or services provided by the external system. Additionally or alternatively, in some embodiments, the services request data object includes particular data for use in coordinating communications between the external system and the identification and login system, and/or such communications in conjunction with communications with the apparatus 300. For example, the apparatus 300 may transmit the services request data object including a session identifier or other unique identifier used to coordinate communications between the various devices and/or systems.

At block 1304, the apparatus 300 includes means, such as auto-login module 310, system identification module 312, communications module 308, processor 302, and/or the like, or a combination thereof, configured to receive a services authentication URL. The services authentication URL may be received in response to the transmitted services request data object. In some embodiments, the services authentication URL is specially configured by the external system, such that access of the services authentication URL causes a transmission of an authentication request data object to the identification and login system. In this regard, the services authentication URL may provide an endpoint associated with the identification and login system, or a trusted third-party system configured to forward a received transmission to the identification and login system (e.g., a specially configured networked device of a mobile device network). It should be appreciated that, in some embodiments, the services authentication URL comprises a specially configured HTTP request, for example a GET or POST request. Additionally or alternatively, in some embodiments, the services authentication URL is configured based on one or more parameters generated by and/or identified by the external system. For example, the services authentication URL may include, and/or may be configured based on, a session identifier used to coordinate communications between the external system, identification and login system, and/or apparatus 300.

At block 1306, the apparatus 300 includes means, such as auto-login module 310, input/output module 306, communications module 308, processor 302, and/or the like, or a combination thereof, configured to access the services authentication URL, for example to cause transmission of the authentication request data object to an identification and login system. In some embodiments, the apparatus 300 is configured to access the services authentication URL automatically upon receiving the services authentication URL from the external system. For example, using software, hardware, firmware, or a combination thereof, the apparatus 300 may be to redirect an executed software application (e.g., a browser application or native software application) to access the services authentication URL. In other embodiments, the apparatus 300 is configured to access the services authentication URL in response to user interaction with an interface rendered via the apparatus 300. For example, in some embodiments, the interface rendered includes a confirmation interface element configured to receive user interaction data for initiating and/or cancelling access of the services authentication URL.

In some embodiments, accessing the services authentication URL causes the apparatus 300 to transmit the authentication request data object to the identification and login system. In some embodiments, for example, the authentication request data object is specially configured to identify the external system and/or particular services requested. In this regard, the authentication request data object may be specially configured, for example by the external system and/or apparatus 300, to include an external system identifier, session identifier, services request identifier, and/or other information associated with the apparatus 300. In some embodiments, the apparatus 300 is configured to transmit the authentication request data object in a particular manner to cause identification of corresponding device identification information using an out-of-band identification process. For example, in a particular context, the apparatus 300 may access the services authentication URL to cause transmission of the authentication request data object through a mobile device network using one of the processes described above with respect to FIG. 12. In some such contexts, the apparatus 300 transmits the authentication request data object to cause identification of the device identification information by a networked device of the mobile device network using a header enrichment process.

In some embodiments, after block 1306, flow returns to one or more of the blocks depicted with respect to FIG. 11. For example, in some embodiments, flow continues to block 1102 as illustrated in FIG. 11.

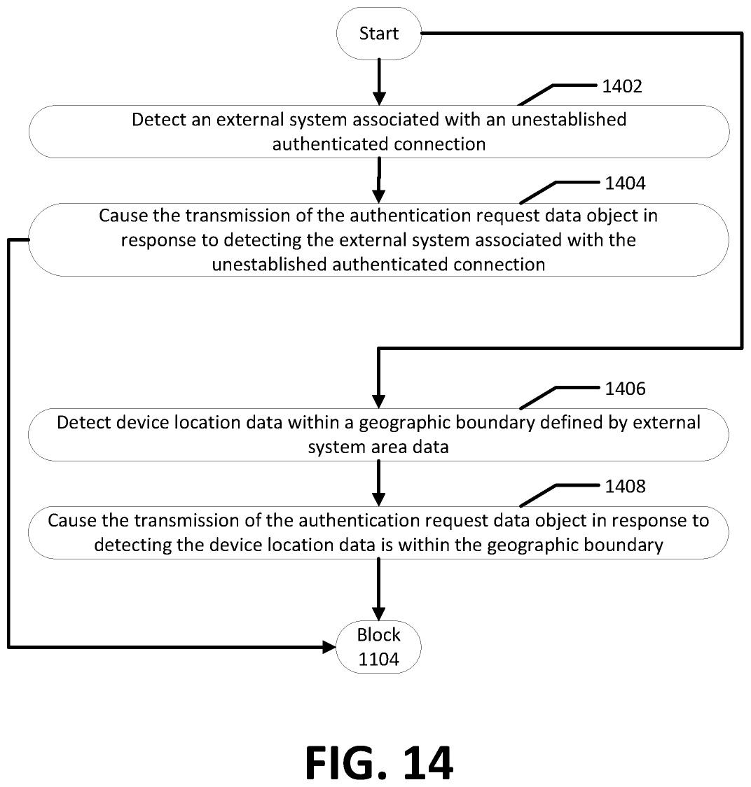

FIG. 14 illustrates additional example operations for secure access credential management, in accordance with some example embodiments of the present disclosure. In some embodiments, one or more of the operations depicted with respect to FIG. 14 is/are performed in addition to, or alternative to, the operations depicted with respect to FIG. 11. In some embodiments, the operations depicted are performed by a specially configured client device, for example a specially configured client device 108 embodied by the apparatus 300.

In some embodiments, the process depicted in FIG. 14 begins at block 1402, which may occur after one or more blocks as illustrated in FIG. 11 or may begin the flow. At block 1302, the apparatus 300 includes means, such as auto-login module 310, system identification module 312, input/output module 306, communications module 308, processor 302, and/or the like, or a combination thereof, configured to detect an external system associated with an unestablished authenticated connection. In some embodiments, for example, the apparatus 300 is configured to scan for external systems that provide particular functionality and are accessible to the apparatus 300. In a particular context, the apparatus 300 is configured to utilize hardware, software, firmware, and/or a combination thereof, to detect an external system embodied by a wireless access point for accessing a particular wireless data network that the apparatus 300 is not yet authenticated to access (e.g., a public Wi-Fi network secured by a network password). In some such embodiments, the apparatus 300 is configured to detect the external system by detecting a network name or SSID associated with the external system. The apparatus 300 may be configured to output particular signals that are configured to cause accessible external systems within a particular range (e.g., a signal range dependent on signal strength and signal type emitted by the apparatus 300) to provide a response transmission to detect the external systems.

At block 1404, the apparatus 300 includes means, such as auto-login module 310, system identification module 312, communications module 308, processor 302, and/or the like, or a combination thereof, configured to cause transmission of the authentication request data object in response to detecting the external system associated with the unestablished authenticated connection. In this regard, the apparatus 300 may generate and/or transmit the authentication request data object for transmission to the identification and login system. In some embodiments, the authentication request data object includes information identifying the detected external system, for example an external system identifier received from the external system and/or determined by the apparatus 300. Additionally or alternatively, the authentication request data object may include a session identifier and/or other information for coordinating communication between the external system, identification and login system, and/or apparatus 300. In some embodiments, the apparatus 300 is configured to transmit the authentication request data object to a predetermined endpoint accessible to the apparatus 300. In other embodiments, the apparatus 300 is configured to receive an endpoint representing a device to which the authentication request data object is to be transmitted.

It should be appreciated that, in some embodiments, the apparatus 300 transmits the authentication request data object directly to the identification and login system. In other embodiments, the apparatus 300 transmits the authentication request data object indirectly to the identification and login system, for example by transmitting the authentication request data object to a trusted third-party system (such as a networked device of a mobile carrier network) configured to forward the authentication request data object, and/or additional information such as identified device identification information, to the identification and login system. For example, in a particular context, the apparatus 300 cause transmission of the authentication request data object through a mobile device network using one of the processes described above with respect to FIG. 12. In some such contexts, the apparatus 300 transmits the authentication request data object to cause identification of the device identification information by a networked device of the mobile device network, for example using a header enrichment process, to be used by the identification and login system.

In other embodiments, the process depicted in FIG. 14 begins at block 1406, which may occur after one or more blocks as illustrated in FIG. 11 or may begin the flow. At block 1406, the apparatus 300 includes means, such as auto-login module 310, system identification module 312, input/output module 306, communications module 308, processor 302, and/or the like, or a combination thereof, configured to detect device location data within a geographic boundary defined by external system area data for a particular external system. In some embodiments, the device location data is detected using location services hardware, software, and/or firmware. For example, in some embodiments, the apparatus 300 is configured to detect device location data using one or more of GPS location services, cell tower triangulation, Wi-Fi signatures, Bluetooth signal proximity, or a combination thereof. In other embodiments, other known methods for device location data detection may be used.

The apparatus 300 may detect, retrieve, or receive external system area data for an associated external system. For example, in some embodiments, the apparatus 300 is configured to receive user interaction indicating external system area data for a particular external system. Additionally or alternatively, in some embodiments, the apparatus 300 is configured to receive external system area data from the external system or an associated system. For example, the apparatus 300 may receive the external system area data in response to one or more signals emitted by the apparatus 300 (e.g., to detect nearby external systems, such as network access points for a wireless data network). In other embodiments, the apparatus 300 receives the external system area data during a previously established authenticated connection with the external system. The apparatus 300 may store such external system area data when received and/or detected, and later retrieve the external system area data in performing such detection.

The external system area data represents a particular geographic boundary associated with the external system. The geographic boundary may, for example, represent the area within which signals from the external system can be received. Alternatively or additionally, the geographic boundary may represent a store, point of interest, or other location associated with the external system. For example, in a particular context, the external system is a wireless access point for a public Wi-Fi network associated with a coffee shop, where the geographic boundary defined by the external system area data for the external system represents the area located within the store. In this regard, where the apparatus 300 has stored and/or received such external system area data defining the geographic boundary, the apparatus 300 may determine whether the apparatus 300 is located within the coffee shop. For example, in some embodiments, the apparatus 300 is configured to compare the device location data and external system area to determine whether the device location data is within the geographic boundary. It should be appreciated that for purposes of detecting whether the device location data is within the geographic boundary defined by the external system area data, in some embodiments, any of a number of known location data comparison methodologies may be utilized.

At block 1408, the apparatus 300 includes means, such as auto-login module 310, system identification module 312, communications module 308, processor 302, and/or the like, or a combination thereof, configured to cause the transmission of the authentication request data object in response to detecting the device location data is within the geographic boundary. In an example context, the apparatus 300 determines the device location data is within the geographic boundary, and in response generates the authentication request data object for transmission. In at least some embodiments, the apparatus 300 may cause transmission of the authentication request data object as described above with respect to block 1404.

In some embodiments, after block 1404 and/or block 1408, flow returns to one or more of the blocks depicted with respect to FIG. 11. For example, in some embodiments, flow continues to block 1104 as illustrated in FIG. 11.

### Alternative Example Data Flow

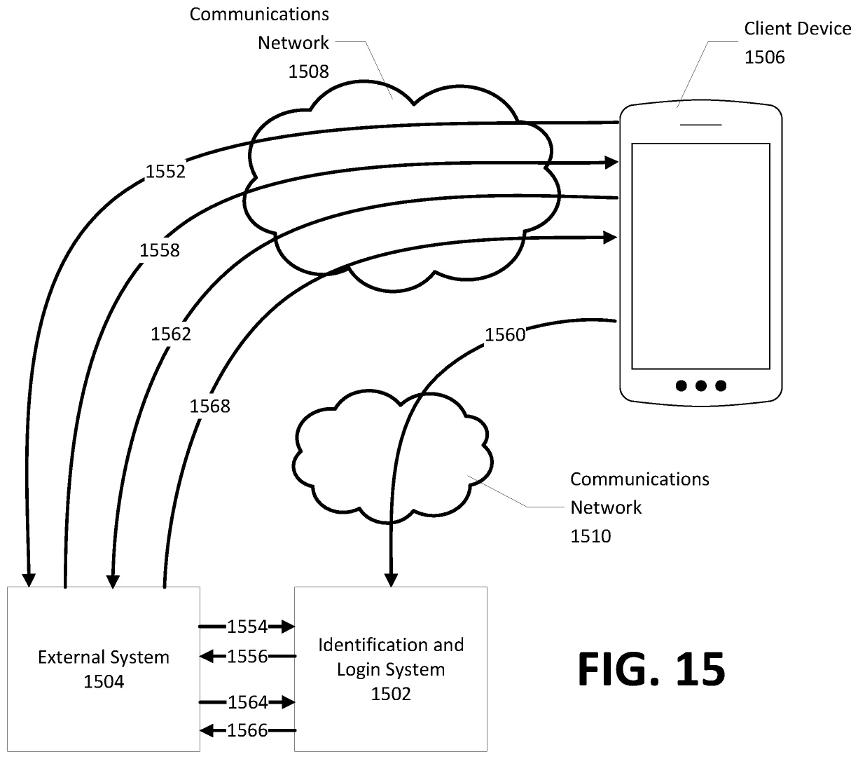

FIG. 15 illustrates yet another example data flow diagram of an example system in accordance with example embodiments of the present disclosure. Specifically, FIG. 15 illustrates an example data flow between an identification and login system 1502, external system 1504, and client device 1506. The external system 1504 may be a remote or cloud system, or located proximate to the client device 1506. The client device 1506 may communicate with the external system 1504 via one or more communications network, such as the communications network 1508. The communications network 1508 may be embodied by a wireless data network (such as a Wi-Fi network) or mobile device network (such as a mobile carrier network) accessible to the client device 1506. The client device 1506 may further communicate with the identification and login system 1502 via one or more communications network, such as the communications network 1510. The communications network 1510 may be embodied by a mobile device network accessible to the client device 1506, or other communications network including one or more trusted third-party system configured to perform an out-of-band identification process. It should be appreciated that, in some embodiments, the communications network 1508 and communications network 1510 are embodied by the same network. For example, in one such context, the client device 1506 communicates with the external system 1504 and identification and login system 1502 via a mobile device network accessible to the client device 1506. Further, it should be appreciated that the external system 1504 may communicate over another communications network (not shown). For example, in some embodiments, the external system 1504 and identification and login system 1502 are configured to communicate over one or more public networks (e.g., the Internet) or, additionally or alternatively, one or more private networks (e.g., a LAN, WLAN, PAN, or the like).

In the illustrated system, the client device 1506 is configured to request services from external system 1504. The external system 1504 is configured to facilitate authentication and/or verification of the identity of the client device 1506 (and/or an associated user) through communication with the identification and login system 1502. Specifically, the identification and login system 1502 may provide highly trustworthy authentication using device identification information associated with the client device 1506. In an example context, the device identification information is identified using an out-of-band identification process performed by a trusted third-party system, such that the accuracy and authenticity of the device identification information is highly trustworthy. The identification and login system 1502 may provide such device identification information and/or associated information, such as access credentials, to the external system 1504 for use in various actions, determinations, and/or the like.

The illustrated data flow includes steps 1552-1568. At step 1552, the client device 1506 transmits a services request data object to the external system 1504. In some such embodiments, the services request data object is transmitted automatically, for example, in response to detecting the external system 1504 or detecting the client device 1506 is within a geographic boundary associated with the external system 1504. In other embodiments, the services request data object is transmitted in response to user interaction with the client device 1506, for example user interaction that indicates a user desire to access functionality provided by the external system 1504. In one example context, the services request data object may represent a user request to initiate an authenticated connection with the external system 1504 (e.g., connect to a wireless device network using the external system 1504 or login to access functionality provided through the external system 1504). In another example context, the services request data object may represent a user request to initiate a transaction with the external system 1504 (e.g., a payment, a high-value transaction, a transfer of electronically managed currency, or the like) or other action where a high level of authentication is desired. As illustrated, the client device 1506 transmits the services request data object via the communications network 1508.

In response to receiving the services request data object, the external system 1504 performs any number of operations for processing and/or handling the services request data object. In this regard, at block 1554, the external system 1504 may at least request a services authentication URL from the identification and login system 1502. The services authentication URL may be specially associated with the authentication request data object, for example by including or otherwise being associated with a session identifier, such that the client device 1506 may utilize the services request URL to provide sufficient information to the identification and login system 1502 for processing the request data object.

The identification and login system 1502 is configured to generate the services authentication URL alone or in conjunction with the external system 1504. In some embodiments, the external system 1504 forwards the services request data object, or a portion of the information therein, to the identification and login system 1502 for use in generating the services authentication URL. For example, in some embodiments, the services request data object received from the client device includes user-submitted and/or device-asserted identification information, such as a phone number input by the user or automatically included by the client device 1506. Alternatively, in some embodiments, the external system 1504 requests the services authentication URL without providing such information for use by the identification and login system 1502.

At step 1556, the identification and login system 1502 provides the services authentication URL to the external system 1504. In some embodiments, upon receiving the services authentication URL, the external system 1504 is configured to further configure the services authentication URL. For example, in an example context, the external system 1504 may be configured to include information from and/or based on the services request data object in the services authentication URL, such as by including information not forwarded to the identification and login system 1502 as one or more parameter values. Alternatively or additionally, in some embodiments, the external system 1504 is configured to automatically provide the services authentication URL to the client device in response to receiving the services authentication URL from the identification and login system 1502.

At step 1558, the external system 1504 is configured to provide the services authentication URL to the client device 1506. In some embodiments, at step 1558, the external system 1504 is configured to generate and/or transmit a response data object including the configured services authentication URL to the client device 1506. In some embodiments, the response data object may include various additional information, such as metadata associated with the services authentication URL and/or services request data object. In some embodiments, the client device 1506 is configured to provide one or more interfaces for accessing the services authentication URL. For example, in some embodiments, the client device 1506 is configured to render an interface including the services authentication URL as an interface element, such that the user may initiate access of the services authentication URL through interaction with the interface element. In other embodiments, the client device 1506 is configured to render a confirmation interface for approving and/or cancelling automatically initiated access of the services authentication URL (e.g., a pop-up interface, notification, or the like). In yet other embodiments, the client device is configured to automatically access the services authentication URL upon receiving the response data object.

At step 1560, the client device accesses the services authentication URL to cause transmission of data packets to the identification and login system to cause identification of device identification information using an out-of-band identification process. For example, as illustrated, the client device 1506 is configured to transmit one or more data packets (for example, embodying an authentication request data object) to the identification and login system 1502 via the communications network 1510. In an example context, the communications network 1510 embodies a mobile carrier network accessible by the client device 1506. The services authentication URL may identify a particular networked device of the communications network 1510, for example such that the networked device is configured to perform an out-of-band identification process to identify device identification information associated with the client device 1506 and forward the device identification information to the identification and login system 1502. The networked device may utilize the transmitted data packets in the out-of-band identification process. For example, in one example context, the network device associated with the mobile carrier network is configured to identify the mobile telephone number associated with the client device 1506 or other identifying account information as the data packets are received by the networked device. In some embodiments, the mobile telephone number (or other device identification information) is identified through a header enrichment process, or other out-of-band identification process, that leverages highly secured information identification methodologies, for example SIM, iSIM, and/or eSIM technologies traditionally used for mobile account billing. It should be appreciated that, in other embodiments, another data network and/or data flow is utilized to initiate the out-of-band identification process. For example, the client device 1506 may transmit the data packets directly to the identification and logins system 1502 to cause the identification and login system 1502 to transmit the data packets and/or associated information to a trusted third-party system, and receives the device identification information in response.

In some embodiments, the client device 1506 is configured to cause transmission of the data packets in a particular manner based on the device type, device configuration, device capabilities, and/or other operating conditions. For example, in one such context, the client device 1506 is configured to utilize the communications network 1510 for such transmissions by default, such that specialized action is not required. In another context, the client device 1506 is configured to enable application-level control, such that the client device may utilize application-level APIs to deactivate a networked connection with a wireless data network (e.g., with communications network 1508) and/or otherwise activate a primary connection with the mobile device network (e.g., a communications network 1510). In yet another context, the client device 1506 is configured to enable device-level data network connectivity, such that one or more low-level API call(s) is/are required to facilitate the transmission. In this regard, the client device 1506 may cause transmission of the data packets as described above with respect to transmission of the authentication request data object in FIG. 12.

After transmitting the data packets, at step 1562, the client device 1506 is configured to notify the external system 1504 that a transmission has been sent to the identification and login system 1502. In some embodiments, for example, the client device 1506 is configured to generate and/or transmit an authentication notification data object to the external system. In some embodiments, the authentication notification data object includes information provided by the client device, for example a session identifier or other unique identifier used to coordinate communications between the various devices. Alternatively or additionally, in some embodiments, the authentication notification data object is configured includes only information necessary for the external system 1504 to determine that the data represents a notification of the transmission to the identification and login system. For example, in an example context, the authentication notification data object includes a specific identifier that corresponds to such a notification, such that the external system 1504 may utilize the identifier to determine the identification and login system is ready to be contacted.

At step 1564, the external system 1504 queries the identification and login system 1504 for information identified associated with the client device 1506. For example, in some embodiments, to query the identification and login system 1502, the external system 1504 is configured to generate and/or transmit a services identity request data object to the identification and login system 1502. The services identity request data object may be configured to represent a query for particular information, for example identified device identification information, corresponding access credentials, other device identifier(s) and/or account information, and/or a combination thereof. In other embodiments, the services identity request data object is configured to request an authentication from the identification and login system 1502. For example, the services identity request data object may include or be associated with earlier an received user-submitted or device-asserted mobile phone number associated with the client device 1506, such that the identification and login system 1502 is to compare such information with the device identification information identified via the out-of-band identification process to determine whether the client device 1506, and/or corresponding user, is successfully identified.

At step 1566, the identification and login system 1502 transmits a response data object to the external system 1504. In some embodiments, the response data object includes information associated with the client device 1506, for example device identification information, corresponding access credentials, or the like. In other embodiments, the response data object includes an indication and/or value as to whether the client device 1506 was successfully identified based on information provided via the services identity request data object. For example, in an example context, the response data object includes a binary indicator that is set to a first value if the client device was successfully identified (e.g., a true Boolean value) and a second value if the client device was not successfully identified (e.g., a false Boolean value). In some embodiments, the identification and login system 1502 is configured to compare information included in the services identity request data object with device identification information to determine the response data object (e.g., a user-submitted or device-asserted mobile phone number with a mobile phone number identified using an out-of-band identification process).

The external system 1504 may utilize the information received from the identification and login system for any of a number of actions and/or determinations. For example, in some embodiments, if the received information and/or device identification information indicates the client device 1506 was not successfully identified, the external system 1504 may modify, reject, and/or terminate one or more transactions or other actions associated with an earlier received services request data object. For example, in a particular context, the services request data object received at block 1552 represents a request to complete a high-value transaction via the external system 1504, and the transaction may not be initiated or may be cancelled by the external system 1504 in response to determining or otherwise receiving information indicating the client device 1506 was not successfully identified.

In another context, in the circumstance where the external system determines and/or receives information indicating the identity of the client device 1506 was successfully authenticated, the external system 1504 may continue processing and/or otherwise complete a transaction or other action associated with an earlier received services request data object. For example, in a particular context, the services request data object received. at block 1552 represents a request to complete a high-value transaction via the external system 1504, and the transaction may be processed and completed by the external system 1504 om response to determining or otherwise receiving information indicating the identity associated with client device 1506 was successfully authenticated. In other embodiments, the external system 1504 may complete establishing an authenticated connection with the client device 1506 in response to the information indicating the identity of the client device 1506 was successfully authenticated. For example, the external system 1504 may generate key data or other secure data to be used to facilitate encrypted and/or otherwise secure communications between the client device 1506 and the external system 1504.

At step 1568, the external system 1504 transmits a services response data object to the client device 1506. The services response data object may, for example include information indicating whether the services request data object was successfully processed (e.g., a transaction completed and/or approved, an authenticated connection established, or the like). In some such embodiments, the services response data object includes information representing an error message in a circumstance where the services request data object was not successfully processed. For example, the services response data object may include an error message indicating that the identity of the client device 1506 could not be successfully authenticated with the identification and login system 1502. Alternatively or additionally, in the circumstance where the services request data object was successfully processed, the services response data object may include confirmation data (e.g., a transaction identifier associated with the processed services request data object, or the like), access credentials, or information used to maintain an authenticated connection with the external system 1504. In some embodiments, the client device 1506 is configured to render one or more interfaces in response to receiving the services response data object, for example where the interfaces include one or more interface elements for displaying information included in and/or associated with the services response data object (e.g., an interface element indicating whether the response indicates the services request data object was successfully processed). Alternatively or additionally, the client device 1506 may store the services response data object, or a portion thereof, in a short-term or long-term memory. In one example context, for example where the services response data object includes access credentials or information for maintaining an authenticated connection, the client device 1506 is configured to store such information for use in re-establishing and/or otherwise maintaining the authenticated connection.

### Example Alternative Operations Performed by Components of the Alternative Example System

Having described an alternative example data flow, specific example flowcharts including various operations performed by apparatuses, devices, and/or sub-systems of the above described systems will now be discussed. It should be appreciated that each of the flowcharts depicts another example computer-implemented process that may be performed by one, or more, of the above described apparatuses, systems, or devices. As described above, in regards to the below flowcharts, one or more of the depicted blocks may be optional in some, or all, embodiments. Optional blocks are depicted with broken (dashed) lines.

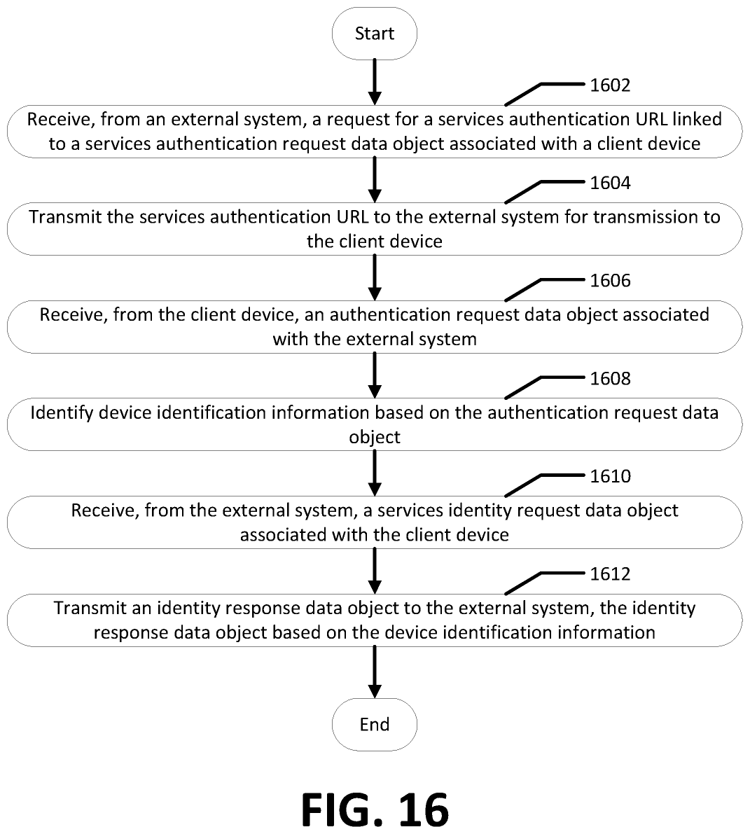

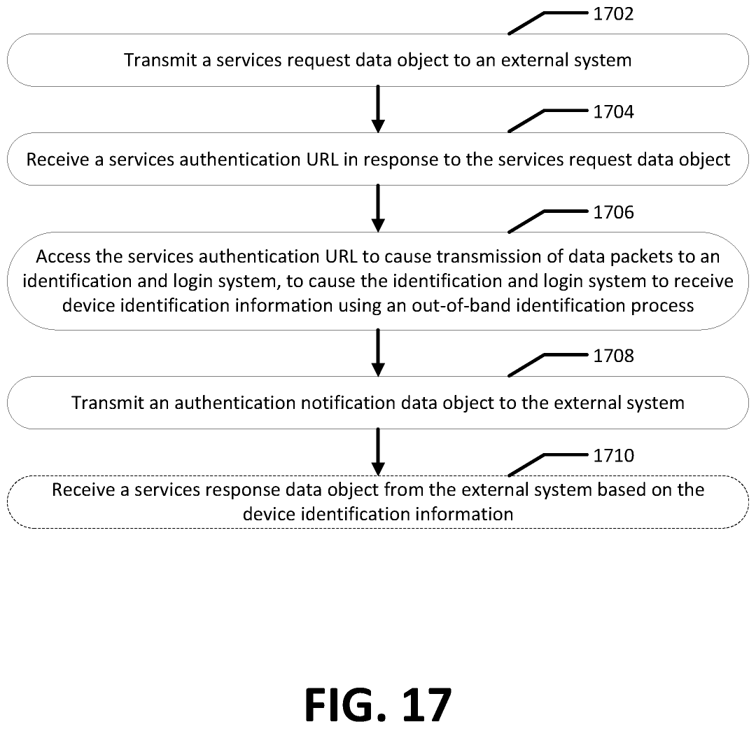

It should be appreciated that the particular operations depicted and described below with respect to FIGS. 16 and 17 illustrate specific operations or steps that may be performed in a particular process. Further, the process may be implemented by computer hardware, software, or a combination thereof, of a system, apparatus, device, or the like, as a computer-implemented method. In other embodiments, the various blocks may represent blocks capable of being performed by an apparatus, device, or system. For example, computer-coded instructions may be specially programmed for performing the various operations depicted and stored for execution by an apparatus, for example in one or more memory devices for execution by one or more processors. In other embodiments, computer program code capable of executing the operations depicted by the various blocks may be stored to one or more non-transitory memory devices associated with a computer program product or other computer readable storage medium.

FIG. 16 illustrates an example process for secure access credential management in accordance with an alternative example embodiment of the present disclosure. The example process illustrated may be performed by an identification and login system, for example an identification and login system 102 embodied by the apparatus 200. In some embodiments, the apparatus 200 may be configured to communicate with one or more other devices, systems, apparatuses, or the like, for receiving and/or transmitting the information described with respect to the example process. For example, the apparatus 200 may communicate with one or more client device(s) and/or one or more external system(s).

At block 1602, the apparatus 200 includes means, such as authentication management module 210, communications module 208, processor 202, and/or the like, or a combination thereof, configured to receive, from an external system, a request for a services authentication URL linked to a services request data object associated with a client device. For example, the client device may have transmitted the services request data object to the external system to cause the external system to transmit the request for the services authentication URL to the external system. In some embodiments, the request for a services authentication URL is embodied by a particular request data object configured by the external system. In some such embodiments, the request data object includes information for use by the apparatus 200 in transmitting the services authentication URL. For example, in at least one example context, the request data object includes a session identifier or other information for coordinating communications between the external system, client device, and apparatus 200.

At block 1604, the apparatus 200 includes means, such as authentication management module 210, communications module 208, processor 202, and/or the like, or a combination thereof, configured to transmit the services authentication URL to the external system. In this regard, the apparatus 200 may transmit the services authentication URL to cause the external system to forward and/or otherwise transmit the services authentication URL to the client device. In some embodiments, the apparatus 200 is configured to generate the services authentication URL such that the services authentication URL is uniquely linked to the services request data object associated with a client device. For example, in a particular context, the apparatus 200 may generate a session identifier to include in the services authentication URL (for example, as one or more parameters). Alternatively or additionally, the apparatus 200 may identify a session identifier, or other information, from the request data object received from the external system. In some embodiments, the services authentication URL represents an endpoint located at the apparatus 200 such that client device is configured to transmit one or more data packets to the apparatus 200 in response to accessing the services authentication URL. In other embodiments, the services authentication URL represents an endpoint located at a trusted third-party system configured to perform an out-of-band identification process, and/or forward received data packets and/or other identified information (for example, device identification information) to the apparatus 200. In some embodiments, the apparatus 200 configures the services authentication URL based on a device type or other device identifies associated with the client device (for example, where particular device types or device identifier(s) are associated with particular trusted third-party system(s)).

At block 1606, the apparatus 200 includes means, such as authentication management module 210, communications module 208, processor 202, and/or the like, or a combination thereof, configured to receive, from the client device, an authentication request data object associated with the external system. The authentication request data object may be received in response to access, by the client device, of the services authentication URL. In some embodiments, the authentication request data object includes or is received associated with device identification information identified by the trusted third-party system, and forwarded to the apparatus 200. For example, in some embodiments in response to accessing the services authentication URL, the client device is configured to transmit the authentication request data object via a mobile device network comprising at least one networked device configured to perform an out-of-band identification process as data packets are received by the networked device. In a particular context, the at least one networked device is configured to perform a header enrichment process to identify the device identification information associated with the authentication request data object as the authentication request data object is received, and injects the identified device identification information into the authentication request data object for forwarding to the apparatus 200. Additionally or alternatively, in some embodiments, the authentication request data object includes other user-input information and/or device-asserted information for processing by the apparatus 200.

At block 1608, the apparatus 200 includes means, such as authentication management module 210, communications module 208, processor 202, and/or the like, or a combination thereof, configured to identify the device identification information based on the authentication request data object. In some embodiments, the device identification information is identified by parsing the device identification information from the authentication request data object, for example where the device identification information was injected into the authentication request data object by a trusted third-party system using an out-of-band identification process (e.g., using a header enrichment process performed by a carrier network over which the authentication request data object was transmitted).

In some embodiments, the device identification information is associated with the client device, for example such that the device identification information is trusted to serve as a proxy for identification of the client device and/or an associated user. For example, in a particular example context, the device identification information represents a mobile phone number associated with the client device. In this regard, the device identification information is associated with a mobile device that is often kept in close proximity to the owner, and secured by one or more authentication processes (e.g., a passcode, password, biometric confirmation(s), and/or the like). In this regard, access to the client device serves as a proxy that the user associated with the client device

In some embodiments, the apparatus 200 communicates with one or more trusted third-party system(s) to identify the device identification information. For example, the apparatus 200 may forward the authentication request data object, and/or other received information (for example received supplemental information) to the trusted third-party system, to cause the trusted third-party system to perform an out-of-band identification process to identify the device identification information, and forward the device identification information to the apparatus 200 in response. In some such embodiments, in this regard, the apparatus 200 is configured to identify the device identification information based on the authentication request data object through cooperation with one or more trusted third-party system(s) configured to perform a trusted out-of-band identification process. The device identification information is identified via a highly-secure process, and thus is trusted to be associated with the client device and can be used for subsequent authentication and other operations.

At block 1610, the apparatus 200 includes means, such as authentication management module 210, communications module 208, processor 202, and/or the like, or a combination thereof, configured to receive, from the external system, a services identity request data object associated with the client device. The services identity request data object may indicate a request to receive the device identification information, and/or a confirmation as to whether the identity associated with the client device that transmitted the services request data object to the external system. In some embodiments, the services identity request data object includes information to be used in identifying and/or transmitting information in response to the services identity request data object, for example user-input information, device-asserted information, or a session identifier.

At block 1612, the apparatus 200 includes means, such as authentication management module 210, communications module 208, processor 202, and/or the like, or a combination thereof, configured to transmit an identity response data object to the external system, where the identity response data object is based on the device identification information. In some embodiments, for example, the identity response data object includes or is embodied by the device identification information, or information derived therefrom, identified associated with the client device. For example, the device identification information may be transmitted to the external system to enable the external system to determine whether the device identification matches device information previously received by the external system from the client device. In other embodiments, the identity response data object includes access credentials identified and/or retrieved as associated with the client device and/or external system, for example as described above. In yet other embodiments, the identity response data object includes an indicator as to whether the identity of the client device was successfully authenticated based on the device identification information. For example, the apparatus 200 may receive user-input and/or device-asserted device information embodied within the services identity request data object (e.g., a mobile phone number input by the user and/or automatically transmitted by the client device to the external system and asserted as authentic) and compare this device information with the identified device identification information.

In some embodiments, the services identity request data object includes information for use in correlating the services identity request data object with a particular authentication request data object and/or corresponding device identification information. For example, in some embodiments, the earlier-received authentication request data object includes or is otherwise associated with a particular session identifier, such that the apparatus 200 may similarly associate the corresponding device identification information identified in response to the authentication request data object with the same session identifier. In a particular context, the apparatus 200 parses user-input and/or device-asserted device information and a session identifier from the services identity request data object, such that the session identifier may be used to identify associated device identification information for such comparison.

FIG. 17 illustrates another example process for secure access credential management in accordance with an example embodiment of the present disclosure. The example process illustrated may be performed by a specially configured client device, for example a client device 108 embodied by the apparatus 300. In some embodiments, the apparatus 300 may be configured to communicate with one or more other devices, systems, apparatuses, or the like, for receiving and/or transmitting the information described with respect to the example process. For example, the apparatus 300 may communicate with an identification and login system and/or one or more external system(s).

At block 1702, the apparatus 300 includes means, such as auto-login module 310, system identification module 312, input/output module 306, communications module 308, processor 302, and/or the like, or a combination thereof, configured to transmit a services request data object to an external system. In some embodiments, for example, the apparatus 300 is configured to present one or more interfaces for a user to select an external system with which the user would like to initiate an authenticated connection. In some such embodiments, the apparatus 300 is configured to receive user interaction data indicative of a user desire to initiate an authenticated connection with the external system. The apparatus 300 may generate and/or transmit the services request data object to the external system in response to the user interaction data. In other embodiments, the apparatus 300 is configured to transmit the services request data object automatically in response to one or more detected events, for example as described above with respect to FIG. 14. The services request data object may be specially configured to represent a request for particular functionality provided by the external system, for example a transaction or access to other functionality requiring an authenticated connection, as described above.

At block 1704, the apparatus 300 includes means, such as auto-login module 310, system identification module 312, communications module 308, processor 302, and/or the like, or a combination thereof, configured to receive a services authentication URL. The services authentication URL may be received in response to the transmitted services request data object. In some embodiments, the services authentication URL is specially configured by the external system, such that access of the services authentication URL causes a transmission of one or more data packets, for example embodying an authentication request data object, to the identification and login system. In this regard, the services authentication URL may provide an endpoint associated with the identification and login system, or a trusted third-party system configured to forward a received transmission to the identification and login system (e.g., a specially configured networked device of a mobile device network). It should be appreciated that, in some embodiments, the services authentication URL comprises a specially configured HTTP request, for example a GET or POST request. Additionally or alternatively, in some embodiments, the services authentication URL is configured based on one or more parameters generated by and/or identified by the external system. For example, the services authentication URL may include, and/or may be configured based on, a session identifier used to coordinate communications between the external system, identification and login system, and/or apparatus 300.

At block 1706, the apparatus 300 includes means, such as auto-login module 310, input/output module 306, communications module 308, processor 302, and/or the like, or a combination thereof, configured to access the services authentication URL, for example to cause transmission of data packets to an identification and login system to cause the identification and login system to receive device identification using an out-of-band identification process. In some embodiments, the apparatus 300 is configured to access the services authentication URL automatically upon receiving the services authentication URL from the external system. For example, using software, hardware, firmware, or a combination thereof, the apparatus 300 may be to redirect an executed software application (e.g., a browser application or native software application) to access the services authentication URL. In other embodiments, the apparatus 300 is configured to access the services authentication URL in response to user interaction with an interface rendered via the apparatus 300. For example, in some embodiments, the interface rendered includes a confirmation interface element configured to receive user interaction data for initiating and/or cancelling access of the services authentication URL.

In some embodiments, accessing the services authentication URL causes the apparatus 300 to transmit data packets embodying an authentication request data object to the identification and login system. In some embodiments, for example, the authentication request data object is specially configured to include information associated with the apparatus 300, the external system and/or particular services requested from the external system via the services request data object. In this regard, the authentication request data object may include an external system identifier, session identifier, services request identifier, and/or other information associated with the apparatus 300. In some embodiments, the apparatus 300 is configured to transmit the authentication request data object in a particular manner to cause identification of the corresponding device identification information using an out-of-band identification process. For example, in a particular context, the apparatus 300 may access the services authentication URL to cause transmission of the authentication request data object through a mobile device network using one of the processes described above with respect to FIG. 12. In some such contexts, the apparatus 300 transmits the authentication request data object to cause identification of the device identification information by a networked device of the mobile device network using a header enrichment process.

At block 1708, the apparatus 300 includes means, such as auto-login module 310, system identification module 312, communications module 308, processor 302, and/or the like, or a combination thereof, configured to transmit an authentication notification data object to the external system. In some embodiments, the authentication notification data object includes a session identifier or other unique identifier used to coordinate communications between the various devices, which may have been generated by the external system at an earlier block (e.g., and received in response to block 1702), generated by the apparatus 300, or generated by the identification and login system (e.g., and received in response to block 1706). Alternatively or additionally, in some embodiments, the authentication notification data object is configured includes only information necessary for the external system to identify the data object as a notification of the transmission to the identification and login system. For example, in an example context, the authentication notification data object includes a specific identifier that corresponds to such a notification, such that the external system may utilize the identifier to determine the identification and login system is ready to be contacted. In some such embodiments, the authentication notification data object is configured to cause the external system to query and/or otherwise communicate with the identification and login system for purposes of authenticating the identity associated with the apparatus 300 or the corresponding user. In some such embodiments, if the external device successfully authenticates the identity of the apparatus 300, the external system may be caused to complete functionality associated with and/or continue processing the earlier-transmitted services request data object (e.g., complete a requested transaction associated with the services request data object).

At optional block 1710, the apparatus 300 includes means, such as auto-login module 310, system identification module 312, communications module 308, processor 302, and/or the like, or a combination thereof, configured to receive a services response data object from the external system. In a particular example context, the services response data object is received based on the device identification information. For example, in a circumstance where the external system was able to verify with the identification and login system that the device identification information successfully authenticates the identity of the apparatus 300, the services response data object may include information indicating the successful authentication. Additionally or alternatively, in some embodiments, the services response data object includes information associated with the functionality requested in the services request data object (e.g., transaction information and/or confirmation information, access credentials, or the like). In some embodiments, the apparatus 300 is configured to store some or all of the information provided in the services response data object, and/or utilize such information for further processing (e.g., to maintain an authenticated connection).

It should be appreciated that, in some embodiments, the apparatus configured for performing the operations described with respect to FIG. 16 or FIG. 17 is similarly configured to perform one or more of the operations described above with respect to FIGS. 5-10 and FIGS. 11-14. For example, the specially configured apparatus 200 may be configured to perform the operations described with respect to FIG. 16 and one or more of the operations described above with respect to FIGS. 5-10. Additionally or alternatively, the specially configured apparatus 300 may be configured to perform the operations described with respect to FIG. 17 and one or more of the operations described above with respect to FIGS. 11-14. For brevity, such repeated disclosure is omitted.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., a FPGA or an ASIC. The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus for secure access credential management, the apparatus comprising at least one processor and at least one non-transitory memory including computer program code, the at least one non-transitory memory and the computer program code, with the at least one processor, configure the apparatus to:
receive, from a client device, an authentication request data object, associated with an external system;
identify device identification information based on the authentication request data object, wherein the device identification information is associated with the client device;
compare the device identification information with a permissioned device information data object;
identify access credentials associated with the external system; and
transmit an authentication information data object comprising the access credentials to the client device.

2. The apparatus of claim 1, wherein to identify the device identification information, the apparatus is configured to:
parse the authentication request data object to identify the device identification information included in the authentication request data object by a trusted third-party system.

3. The apparatus of claim 1, wherein to identify the device identification information, the apparatus is configured to:
transmit, to a trusted third-party system, a third-party authentication request data object configured based on the authentication request data object; and
receive the device identification information from the trusted third-party system in response to the third-party authentication request data object.

4. The apparatus of claim 1, the apparatus further configured to:
identify effective time data associated with the access credentials,
wherein the authentication information data object further comprises the effective time data.

5. The apparatus of claim 1, the apparatus further configured to:
store an device location event record, an authentication record, or both, to at least one record datastore based on the authentication request data object.

6. The apparatus of claim 1, the apparatus further configured to:
receive permissible device information from the client device or an admin device; and
update the permissioned device information data object to include the permissible device information.

7. The apparatus of claim 1, the apparatus further configured to:
retrieve the permissioned device information data object from a third-party directory management service.

8. The apparatus of claim 1, the apparatus further configured to:
receive the access credentials from the client device; and
update the permissioned device information data object to include the device identification information.

9. The apparatus of claim 1, the apparatus further configured to:
identify an updated access credentials in response to a credential update event; and
transmit an updated authentication information data object comprising the updated access credentials to each client device of a connected client device set comprising the client device.

10. The apparatus of claim 1, the apparatus further configured to:
receive a permission removal request data object associated with removal device identification information; and
update the permissioned device information data object to remove the removal device identification information.

11. The apparatus of claim 1, the apparatus further configured to:
receive supplemental information associated with the client device via at least one other networked connection, wherein the apparatus is configured to identify the device identification information based on the authentication request data object and at least a portion of the supplemental information.

12. A computer-implemented method for secure access credential management, the method comprising:
receiving, from a client device, an authentication request data object, associated with an external system;
identifying device identification information based on the authentication request data object, wherein the device identification information is associated with the client device;
comparing the device identification information with a permissioned device information data object;
identifying access credentials associated with the external system; and
transmitting an authentication information data object comprising the access credentials to the client device.

13. The computer-implemented method of claim 12, wherein identifying the device identification information comprises:
parsing the authentication request data object to identify the device identification information included in the authentication request data object by a trusted third-party system.

14. (canceled)

15. The computer-implemented method of claim 12, the method further comprising:
identifying effective time data associated with the access credentials,
wherein the authentication information data object further comprises the effective time data.

16. The computer-implemented method of claim 12, the method further comprising:
storing an device location event record, an authentication record, or both, to at least one record datastore based on the authentication request data object.

17. The computer-implemented method of claim 12, the method further comprising:
receiving permissible device information from the client device or an admin device; and
updating the permissioned device information data object to include the permissible device information.

18. (canceled)

19. The computer-implemented method of claim 12, the method further comprising:
receiving the access credentials from the client device; and
updating the permissioned device information data object to include the device identification information.

20. The computer-implemented method of claim 12, the method further comprising:
identifying an updated access credentials in response to a credential update event; and
transmitting an updated authentication information data object comprising the updated access credentials to each client device of a connected client device set comprising the client device.

21. (canceled)

22. The computer-implemented method of claim 12, the method further comprising:
receiving supplemental information associated with the client device via at least one other networked connection, wherein identifying the device identification information is based on the authentication request data object and at least a portion of the supplemental information.

23. A computer program product for secure access credential management, the computer program product comprising at least one non-transitory computer-readable storage medium, the at least one non-transitory computer-readable storage medium having computer program code thereon, the computer program code in execution with at least one processor, configured to:
receive, from a client device, an authentication request data object, associated with an external system;
identify device identification information based on the authentication request data object, wherein the device identification information is associated with the client device;
compare the device identification information with a permissioned device information data object;
identify access credentials associated with the external system; and
transmit an authentication information data object comprising the access credentials to the client device.

24-78. (canceled)
